(19) United States
(12) Patent Application Publication
(10) Pub. No.: US 2009/0068415 A1
(43) Pub. Date: Mar. 12, 2009

(54) INK COMPOSITION, IMAGE-FORMING METHOD AND RECORDED MEDIUM

(75) Inventor: Hiroshi Kawakami, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/912,021

(22) PCT Filed: Apr. 20, 2006
(86) PCT No.: PCT/JP2006/308787

§ 371 Date: Oct. 19, 2007

(30) Foreign Application Priority Data
Apr. 20, 2005 (JP) 2005-122957

(51) Int. Cl. C09D 11/10; C08G 63/68; C08G 63/06; C08L 67/06; B05D 5/00; B05D 3/06; B32B 3/00

(52) U.S. Cl. 428/195.1; 106/31.13; 528/271; 528/361; 524/599; 427/256; 427/487

(57) ABSTRACT

The invention provides an ink composition comprising a polymerizable compound and a metal-containing polymerizable compound and an image-forming method and a recorded medium using the same.

### TECHNICAL FIELD

The present invention relates to an ink composition and an image-forming method using the same, and in particular, to an ink composition that can polymerize and cure after recording and that is suitable to record a rigid image, and an image-forming method using the same and a recorded medium with an image obtained from the same.

### BACKGROUND ART

UV inks that cure by irradiation of ultraviolet (UV) rays and block UV light are known as inks having discoloration resistance (e.g., Japanese Patent Application Laid-Open (JP-A) No. 2003-221528).

In the curing of such an ink, radical polymerization of the monomer component or components thereof is utilized. The monomer component is generally an acrylate monomer (e.g., JP-A Nos. 2003-246818, 2003-292855 and H09-183927).

As described above, when a curable ink that is cured by irradiation of light such as UV rays after recording is used, an image is recorded on a recording medium and the recorded image is polymerized and cured. The cured image has improved rigidity.

However, the adhesiveness between the cured image and the recording medium depends on the composition of the ink and the type of the material of the recording medium. For example, when the recording medium is made of paper, a resin such as PET, a metal, or glass and, therefore, has a smooth surface, the adhesiveness may be insufficient. When force is applied to the image in such a case, for example, by bending the image-formed recording medium or scratching the formed image, the image undesirably peels off and damages relatively easily. Addition of additives for improving adhesiveness to the ink may result in deterioration of other properties such as light resistance.

As described, the polymerization and curing improves the hardness (degree of curing) of the image itself, or the weather resistance of the image with respect to light and ozone. However, when the adhesiveness between the cured image and the recording medium made of, for example, a metal, a resin such as PET, or glass is insufficient, and, in other words, the image has poor peeling resistance, the image cannot be fixed on the recorded medium for a long period of time, and undesirably peels off. Thus, such a recorded medium has a significantly decreased commercial value.

Accordingly, there is a need for an ink composition having strong adhesiveness with respect to a recording medium and allowing formation of a rigid image which does not easily peel off from the recording medium, an image-forming method using the ink composition and providing a rigid image which does not easily peel off from a recording medium, and a recorded medium with an image obtained from the ink composition.

### SUMMARY OF THE INVENTION

A first aspect of the invention provides an ink composition including a polymerizable compound and a metal-containing polymerizable compound.

A second aspect of the invention provides a method for forming an image, including: ejecting the ink composition by ink-jet recording to record an image on a recording medium.

A third aspect of the invention provides a method for forming an image, including: recording an image on a recording medium with the ink composition of and irradiating the image with active energy rays to cure the image.

A fourth aspect of the invention provides a recorded medium having an image recorded by using the ink composition.

### DESCRIPTION OF THE PREFERRED EMBODIMENTS

Hereinafter, the ink composition of the invention and the image-forming method and recorded medium using the same will be described in detail.

### <Ink Composition>

The ink composition of the invention includes at least one metal-containing polymerizable compound and at least one polymerizable compound other than the metal-containing polymerizable compound. The ink composition is applied to a recording medium to record an image on the recording medium, and is irradiated with active energy rays to cure the image. In addition to these components, the ink composition preferably contains at least one polymerization initiator and/or at least one colorant such as a dye or a pigment, and, if necessary, may also include other components such as various additives.

Hereinafter, the term “polymerizable compound” means a polymerizable compound other than metal-containing polymerizable compound.

### —Metal-Containing Polymerizable Compound—

The ink composition of the invention contains as least one metal-containing polymerizable compound. The metal-containing polymerizable compound is a compound that polymerizes and cures in the presence of a polymerization initiator described later during irradiation of active energy rays. Such polymerization of the metal-containing polymerizable compound and a polymerizable compound described later can provide an image more adhesive to a recording medium which is in direct contact with the image than an image obtained from an ink including a polymer rather than a polymerizable compound. Moreover, combined use of the metal-containing polymerizable compound and the polymerizable compound other than the metal-containing polymerizable compound can more improve the adhesion of the ink composition of the invention to a recording medium than a single use of the polymerizable compound. The reason for this is thought to be as follows. The polarity of the metal moiety influences the adhesiveness of the ink to the recording medium. Therefore, the ink composition of the invention can form a rigid image having good scratch resistance on a recording medium, and, even when the image undergoes external force, the image hardly peels off from the recording medium.

The ink composition of the invention is highly adhesive to any recording medium such as metal, resin (e.g., PET), or glass, but shows the advantageous effect particularly on glass or a resin such as PET.

In addition, even when the content of the metal-containing polymerizable compound(s) in the ink composition of the invention is low, the ink concentration after curing can be prevented from decreasing, resulting in increased printing density. Further, the ink composition of the invention can provide an image recorded on a recording medium, whose type can be selected arbitrarily, and having improved resistance to light and/or oxidative gas, particularly, ozone and improved scratch resistance.

The metal-containing polymerizable compound needs to be a polymerizable compound containing at least one metal and otherwise it is not limited. The form of the metal contained in the metal-containing polymerizable compound is not particularly limited. Therefore, the metal contained in the metal-containing polymerizable compound may be, for example, a salt.

The metal-containing polymerizable compound in the invention is preferably a metal carboxylate compound. The metal contained in the metal-containing polymerizable compound is preferably a bivalent metal. Examples thereof include Zn, Ca, and Fe. The metal is more preferably Zn.

The metal carboxylate compound is prepared by reacting a carboxylic acid and a metal compound. The carboxylic acid and the metal compound are not necessarily chemically equivalent. The molecular weight of the carboxylic acid used in the preparation of the metal carboxylate compound is not particularly limited, but is preferably 2,000 or less and still more preferably 1,200 or less. The carboxylic acid used in the preparation of the metal carboxylate compound is particularly preferably acrylic acid or methacrylic acid.

When the ink composition of the invention is used in ink jet recording, the metal-containing polymerizable compound preferably has a low viscosity. Thus, the metal-containing polymerizable compound is preferably a monomer. Alternatively, the metal-containing polymerizable compound may be a polymer when the polymer can be dissolved in the ink composition, and the ink composition has a low viscosity.

The metal-containing polymerizable compound contains at least one metal atom, as described above.

Examples of the metal-containing polymerizable compound include the following compounds.

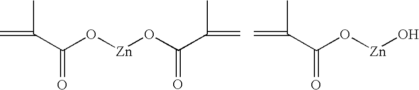

The metal-containing polymerizable compound can be a commercial product. Examples of the commercial product include BLENMER S111 and BLENMER S122 manufactured by NOF Corporation; SR-365C manufactured by Nippon Kayaku Co., Ltd.; SAN ESTER SK-30 manufactured by Sanshin Chemical Industry Co., Ltd.; and zinc monomethacrylate manufactured by Asada Chemical Industry Co. Ltd.

The metal-containing polymerizable compound can show the advantageous effects of the invention, even if the amount thereof in the ink composition is small. Therefore, the metal-containing polymerizable compound is unlikely to affect the curability and/or the sensitivity of the ink composition. When the ratio of the metal-containing polymerizable compound(s) to the polymerizable compound(s) is too high, the curability and/or sensitivity may deteriorate.

The mass ratio of the metal-containing polymerizable compound(s) (y) to the mixture of the polymerizable compound(s) (x) and the metal-containing polymerizable compound(s), (y/(x+y)×100), is preferably 0.2 to 12%, more preferably 0.5 to 12%, and still more preferably 1 to 12% from the viewpoints of the adhesiveness, curability, printing density and sensitivity of the ink composition.

The contents of the metal-containing polymerizable compound(s) and the polymerizable compound(s) in the ink composition are preferably so determined as to satisfy the above-described mass ratio.

### —Polymerizable Compound—

In addition to the metal-containing polymerizable compound(s), the ink composition of the invention further contains at least one other polymerizable compound.

The polymerizable compound is a compound that polymerizes and cures by action of a polymerization initiator described later, specifically, by active species generated by the polymerization initiator during active energy ray irradiation.

The content of the polymerizable compound(s) in the ink composition of the invention is preferably in the range of 98 to 50 mass %, more preferably 95 to 60 mass %, and still more preferably 90 to 70 mass % from the viewpoints of the sensitivity due to polymerization reactivity and the viscosity of the ink composition. In the invention, the polymerizable compound can be selected from radically polymerizable compounds and cationic polymerizable compounds. The polymerizable compound is preferably a non-basic polymerizable compound, considering combined use of the polymerizable compound and the metal-containing polymerizable compound.

Hereinafter, radically and cationic polymerizable compounds will be described mainly.

The radically polymerizable compound is a compound having an ethylenic unsaturated bond capable of being radically polymerized. The radically polymerizable compound may be in any form, as long as it includes at least one ethylenic unsaturated bond capable of being radically polymerized in the molecule thereof. Specifically, the radically polymerizable compound can be a monomer, an oligomer, or a polymer. One type of such a radically polymerizable compound may be used, or, in order to improve intended properties, two or more types thereof may be used in any ratio. Moreover, the radically polymerizable compound is more preferably a polyfunctional compound having two or more functional groups than a monofunctional compound. Combined use of two or more types of the polyfunctional compounds is further preferred in controlling properties such as reactivity and physical properties of the ink composition.

In the ink composition of the invention, a (meth)acrylate compound is preferably used as the radically polymerization compound. Examples of the (meth)acrylate compound include the following compounds:

The term “(meth)acrylate” means both acrylate and methacrylate. The same shall apply hereinafter.

The (meth)acrylate compound can be a monofunctional (meth)acrylate. Typical examples of the monofunctional (meth)acrylate include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethylhexyldiglycol (meth)acrylate, butoxyethyl (meth)acrylate, 2-chloroethyl (meth)acrylate, 4-bromobutyl (meth)acrylate, cyanoethyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-tetrafluoroethyl (meth)acrylate, 1H, 1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethylsuccinic acid, 2-methacryloyloxyhexahydrophthalic acid, 2-methacryloyloxyethyl-2-hydroxypropyl phthalate, butoxy diethylene glycol (meth)acrylate, trifluoroethyl (meth)acrylate, perfluorooctylethyl (meth)acrylate, 2-hydroxy-3-phenoxypropyl (meth)acrylate, ethylene oxide-modified phenol (meth)acrylate, ethylene oxide-modified cresol (meth)acrylate, ethylene oxide-modified nonylphenol (meth)acrylate, polyethylene oxide-modified nonylphenol (meta)acrylate, ethylene oxide-modified 2-ethylhexyl (meth)acrylate, carbitol (meth)acrylate, oligoester (meth)acrylate, epoxy (meth)acrylate, urethane (meth)acrylate, methyl (meth)acrylate, n-butyl (meth)acrylate, lauryl (meth)acrylate, allyl (meth)acrylate, and dimethylaminomethyl (meth)acrylate.

The (meth)acrylate compound can be a bifunctional (meth)acrylate. Typical examples of the bifunctional (meth)acrylate include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol (meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, neopentyl glycol hydroxypivalate di(meth)acrylate, ethylene oxide-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonanedi(meth)acrylate, propoxylated ethoxylated bisphenol A di(meth)acrylate, tricyclodecane di(meth)acrylate, diethylene glycol di(meth)acrylate, triethylene glycol di(meth)acrylate, and tetraethylene glycol di(meth)acrylate.

The (meth)acrylate compound can be a trifunctional (meth)acrylate. Typical examples of the trifunctional (meth)acrylate include trimethylolpropane tri(meth)acrylate, trimethylolethane tri(meth)acrylate, trimethylolpropane alkyleneoxide-modified tri(meth)acrylate, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, dipentaerythritol propionate tri(meth)acrylate, tri((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate, ethoxylated glycerol triacrylate, trimethylolethane tri(meth)acrylate, and trimethylolpropane tri(meth)acrylate.

The (meth)acrylate compound can be a tetrafunctional (meth)acrylate. Typical examples of the tetrafunctional (meth)acrylate include pentaerythritol tetra(meth)acrylate, sorbitol tetra(meth)acrylate, ditrimethyrollpropane tetra(meth)acrylate, dipentaerythritol propionate tetra(meth)acrylate, ethoxylated pentaerythritol tetra(meth)acrylate, dipentaerythritol tetra(meth)acrylate, and tetramethylolmethane tetra(meth)acrylate.

The (meth)acrylate compound can be a pentafunctional (meth)acrylate. Typical examples of pentafunctional (meth)acrylate include sorbitol penta(meth)acrylate, and dipentaerythritol penta(meth)acrylate.

The (meth)acrylate compound can be a hexafunctional (meth)acrylate. Typical examples of the hexafunctional (meth)acrylate include dipentaerythritol haxa(meth)acrylate, sorbitol hexa(meth)acrylate, phosphazene alkylene oxide-modified hexa(meth)acrylate, and captolactone-modified dipentaerythritol hexa(meth)acrylate.

The ink composition of the invention preferably contains, as the polymerizable compounds, at least one trifunctional or higher-functional (meth)acrylate and (b) at least one compound selected from monofunctional and bifunctional (meth)acrylates for adjustment of the viscosity and cross-linking density of the ink composition and control of physical properties (e.g., strength, and/or adhesiveness) of the ink composition after curing.

Examples of the radically polymerizable compound other than the above compounds include unsaturated carboxylic acids such as acrylic acid, methacrylic acid, itaconic acid, crotonic acid, isocrotonic acid, and maleic acid, and salts, esters, urethanes, amides, and anhydrides thereof; acrylonitrile; styrene; unsaturated polyesters; unsaturated polyethers; unsaturated polyamides; and unsaturated urethanes. Typical examples thereof include acrylic acid derivatives such as bis(4-acryloxypolyethoxyphenyl)propane and diacetone acrylamide; methacrylic acid derivatives such as 2,2-bis(4-methacryloxypolyethoxyphenyl)propane; and allyl compounds such as allyl glycidyl ether, diallyl phthalate, and triallyl trimellitate. More specifically, the radically polymerizable compound can be a commercial product described in, for example, “Cross-linking Agent Handbook” (edited by Shinzo Yamashita and published by Taiseisha Co., Ltd. in 1981), “UV-EB Curing Handbook (Raw Materials)” (edited by Kiyoshi Kato, and published by Kobunshi Kankokai in 1985), “Application and Market of UV-EB Curing Technology” (edited by RadTech Japan, and published by CMC Publishing in 1989, p. 79), or “Polyester Resin Handbook” (written by Eiichiro Takiyama, and published by Nikkankogyo Shimbun in 1988), or a radically polymerizable or cross-linkable monomer, oligomer or polymer known in the art.

### —Cationic Polymerizable Compound—

Any one of various cationic polymerizable monomers known as photo-cationic-polymerizable monomers may be used as the cationic polymerizable compound. Examples of the cationic polymerizable monomers include vinyl ether compounds, oxetane compounds, and oxirane compounds described in JP-A Nos. H06-9714, 2001-31892, 2001-40068, 2001-55507, 2001-310938, 2001-310937, and 2001-220526.

Typical examples of the vinyl ether compound include di- and tri-vinylether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, and octadecyl vinyl ether. The vinyl ether compound is preferably a di- or tri-vinyl ether compound from the viewpoints of the curability, adhesiveness of the ink composition to a recording medium, and the surface hardness of a formed image, and is more preferably a divinyl ether compound.

The cationic polymerizable compound is preferably an oxetane group- or oxirane group-containing compound. The compound polymerizes and cures by action of a polymerization initiator described later during active energy ray irradiation. Moreover, the curing reaction progresses in a short period of time. Thus, such a compound is particularly effective in preventing discoloration of a dye, which easily fades, during curing (polymerization reaction) and discoloration of an image after the curing, and has good color tone (hue), density, and definition, and provides an image having light resistance equivalent to that of an image obtained from an ink containing a pigment.

The oxetane group-containing compound is a compound having at least one oxetane group (oxetanyl group) in the molecule thereof, and is preferably a compound having 1 or 2 oxetane groups in the molecule thereof. Typical examples of such a compound include the following compounds (a) to (f).

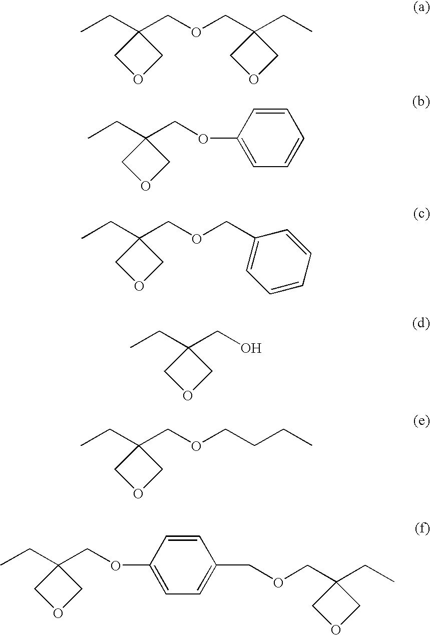

The oxirane group-containing compound can be selected properly from compounds having at least one oxirane group (oxiranyl group) with an oxirane ring in the molecule thereof, for example, epoxy resins commonly used. Examples thereof include aromatic epoxy resins, alicyclic epoxy resins, and aliphatic epoxy resins known in the art. The compound may be a monomer, an oligomer, or a polymer. Typical examples thereof include the following compounds (i) to (viii).

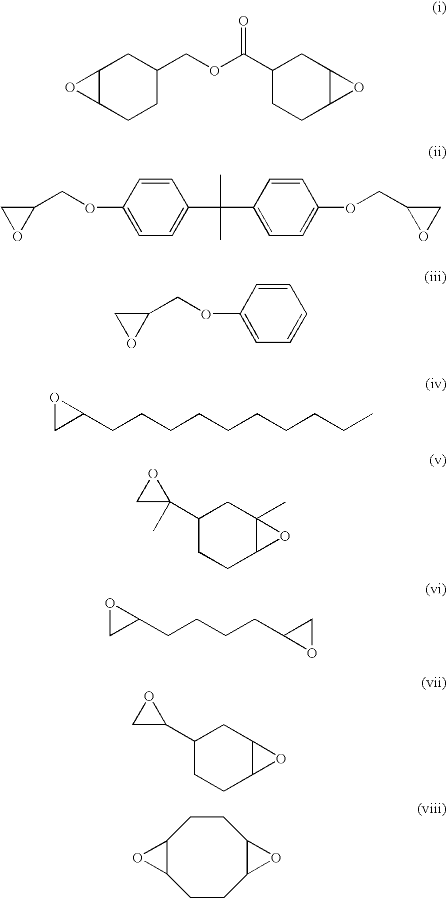

When the oxetane group-containing compound(s) (p) and the oxirane group-containing compound(s) (q) are used together, the content ratio (mass ratio) p/q is preferably in the range of 50/50 to 95/5, and more preferably in the range of 67/33 to 90/10 to further effectively improve the curability of the ink composition and light resistance of the resultant image after curing.

### —Polymerization Initiator—

The ink composition of the invention preferably contains at least one polymerization initiator which causes polymerization and curing of the metal-containing polymerizable compound and the polymerizable compound. The polymerization initiator has absorption in the wavelength range of the active energy rays and, when exposed to the active energy rays, can act on a polymerizable compound, and can accelerate polymerization and curing of the polymerizable compound.

The polymerization initiator is a compound which undergoes the action of active energy rays or interacts with an electronically excited sensitizing dye, chemically changes and generates at least one of radical, acid and base. Typical examples thereof include initiators that, when exposed to active energy rays, generate an active radical species, which initiates and accelerates polymerization and curing of a polymerizable compound (i.e., ink composition) and initiators that, when exposed to active energy rays, generate a cationic species, which initiates and accelerates polymerization and curing of a polymerizable compound (i.e., ink composition). The polymerization initiator can be selected properly from the following polymerization initiators.

In the invention, the “active energy rays” are active rays which cause the polymerization initiator to generate a radical or cation. Examples thereof include ultraviolet rays (UV ray), visible light, γ rays, α rays, X rays and electron beams. Typical examples of a light source include an LD, an LED, a fluorescent lamp, a low-pressure mercury lamp, a high-pressure mercury lamp, a metal halide lamp, a carbon arc lamp, a xenon lamp, and a chemical lamp. The light source is preferably an LED, a high-pressure mercury lamp, or a metal halide lamp.

The polymerization initiator may be any of polymerization initiators known in the art.

Typical examples thereof include compounds described in Bruce M. Monroe et al., Chemical Revue, 93, 435 (1993); R. S. Davidson, Journal of Photochemistry and biology A: Chemistry, 73. 81 (1993); J. P. Faussier “Photoinitiated Polymerization-Theory and Applications”: Rapra Review, vol. 9, Report, Rapra Technology (1998); and M. Tsunooka et al., Prog. Polym. Sci., 21, 1 (1996). The typical examples also include compounds described as chemically amplifying photoresists and as compounds for photo-cationic polymerization in “Organic Materials for Imaging” (edited by Japanese Research Association for Organic Electronics Materials and published by Bun-Shin Shuppan in 1993, p. 187 to 192). Further, the typical examples also include compounds that interact with an electronically excited sensitizing dye to oxidatively or reductively cleave their bond and that are described in F. D. Saeva, Topics in Current Chemistry, 156, 59 (1990); G. G. Maslak, Topics in Current Chemistry, 168, 1 (1993); H. B. Shuster et al., JACS, 112, 6329 (1990); and I. D. F. Eaton et al., JACS, 102, 3298 (1980).

The polymerization initiator is preferably (a) an aromatic ketone, (b) an aromatic onium salt compound, (c) an organic peroxide, (d) a hexaarylbiimidazole compound, (e) a ketoxime ester compound, (f) a borate compound, (g) an azinium salt compound, (i) a metallocene compound, (i) an active ester compound, or (j) a carbon-halogen bond-containing compound.

The aromatic ketone (a) is preferably a compound having a benzophenone or thioxanthone skeleton and described in “Radiation Curing In Polymer Science and Technology” J. P. Fouassier and J. F. Rabek (1993), p. 77 to 117. The aromatic ketone is more preferably an α-thiobenzophenone compound described in Japanese Patent Application Publication (JP-B) No. S47-6416, a benzoin ether compound described in JP-B No. S47-3981, an α-substituted benzoin compound described in JP-B No. S47-22326, a benzoin derivative described in JP-B No. S47-23664, an aroylphosphonate described in JP-A No. S57-30704, a dialkoxybenzophenone described in JP-B No. S60-26483, a benzoin ether described in JP-B No. S60-26403 or JP-A No. S62-81345, an α-aminobenzophenone described in JP-B No. H01-34242, U.S. Pat. No. 4,318,791, or EP No. 0284561A1, a p-di(dimethylaminobenzoyl)benzene described in JP-A No. H02-211452, a thio-substituted aromatic ketone described in JP-A No. S61-194062, an acylphosphine sulfide described in JP-B No. H02-9597, an acylphosphine described in JP-B No. H02-9596, a thioxanthone described in JP-B No. S63-61950, or a coumarin described in JP-B No. S59-42864.

Examples of (b) the aromatic onium salt compound include aromatic onium salts of elements in Groups 15, 16 and 17 of the periodic table, such as N, P, As, Sb, Bi, O, S, Se, Te, and I. Typical examples thereof include iodonium salts described in EP No. 104143, U.S. Pat. No. 4,837,124, JP-A Nos. H02-150848 and H02-96514; sulfonium salts, diazonium salts (such as benzene diazonium that may have at least one substituent) and diazonium salt resins (such as a formaldehyde resin of diazodiphenylamine) described in EP Nos. 370693, 233567, 297443, 297442, 279210, and 422570, and U.S. Pat. Nos. 3,902,144, 4,933,377, 4,760,013, 4,734,444, and 2,833,827; N-alkoxypyridinium salts (for example, those described in U.S. Pat. No. 4,743,528, JP-A Nos. S63-138345, S63-142345, and S63-142346, and JP-B No. S46-42363, such as 1-methoxy-4-phenylpyridinium tetrafluoroborate); and compounds described in JP-B Nos. S52-147277, S52-14278, and S52-14279. These compounds generate a radical or acid as an active species.

The organic peroxide (c) may be an organic compound having one or more oxygen-oxygen bonds in the molecule thereof. Typical examples thereof include peroxyesters such as 3,3′4,4′-tetra-(t-butylperoxycarbonyl)benzophenone, 3,3′4,4′-tetra-(t-amylperoxycarbonyl)benzophenone, 3,3′4,4′-tetra-(t-hexylperoxycarbonyl)benzophenone, 3,3′4,4′-tetra-(t-octylperoxycarbonyl)benzophenone, 3,3′4,4′-tetra-(cumylperoxycarbonyl)benzophenone, 3,3′4,4′-tetra-(p-isopropylcumylperoxycarbonyl)benzophenone, and di-t-butyldiperoxyisophthalate.

Examples of the hexaarylbiimidazole compound (d) include Rofin dimers described in JP-B Nos. S45-37377 and S44-86516, such as 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o, p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole, and 2,2′-bis(o-trifluorophenyl)-4,4′,5,5′-tetraphenylbiimidazole.

Examples of the ketoxime ester compound (e) include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one, and 2-ethoxycarbonyloxyimino-1-phenylpropan-1-one.

Examples of the borate compound (f) include compounds described in U.S. Pat. Nos. 3,567,453, and 4,343,891 and E.P. Nos. 109772 and 109773.

Examples of the azinium salt compound (g) include compounds having an N—O bond described in JP-A Nos. S63-138345, S63-142345, S63-142346, and S63-143537, and JP-B No. S46-42363.

Examples of the metallocene compound (h) include titanocene compounds described in JP-A Nos. S59-152396, S61-151197, S63-41484, H02-249, and H02-4705 and iron-arene complexes described in JP-A Nos. H01-304453 and H01-152109.

Specific examples of the titanocene compound include dicyclopentadienyl-Ti-dichloride, dicyclopentadienyl-Ti-bisphenyl, dicyclopentadienyl-Ti-bis-2,3,4,5,6-pentafluorophenyl-1-yl, dicyclopentadienyl-Ti-bis-2,3,5,6-tetrafluorophenyl-1-yl, dicyclopentadienyl-Ti-bis-2,4,6-trifluorophenyl-1-yl, dicyclopentadienyl-Ti-2,6-di-fluorophenyl-1-yl, dicyclopentadienyl-Ti-bis-2,4-difluorophenyl-1-yl, dimethylcyclopentadienyl-Ti-bis-2,3,4,5,6-pentafluorophenyl-1-yl, dimethylcyclopentadienyl-Ti-bis-2,3,5,6-tetrafluorophenyl-1-yl, dimethylcyclopentadienyl-Ti-bis-2,4-di fluorophenyl-1-yl, bis(cyclopentadienyl)-bis(2,6-difluoro-3-(pir-1-yl)phenyl)titanium, bis(cyclopentadienyl)bis[2,6-difluoro-3-(methylsulfonamido)phenyl] titanium, and bis(cyclopentadienyl)bis[2,6-difluoro-3-(N-butylbiaroyl-amino)phenyl] titanium.

Examples of the active ester compound (i) include nitrobenzyl ester compounds described in EP Nos. 0290750, 046083, 156153, 271851, and 0338343, U.S. Pat. Nos. 3,901,710 and 4,181,531, and JP-A Nos. S60-198538 and S53-133022; iminosulfonate compounds described in EP Nos. 0199672, 84515, 199672, 044115, and 0101122, U.S. Pat. Nos. 4,618,564, 4,371,605, and 4,431,774, and JP-A Nos. S64-18143, H02-245756 and H04-365048; and compounds described in JP-B Nos. S62-6223 and S63-14340, and JP-A No. S59-174831.

Typical examples of the carbon-halogen bond-containing compound (j) include compounds described in Wakabayashi et al., Bull. Chem. Soc. Japan, 42, 2924 (1969), compounds described in British Patent No. 1388492, compounds described in JP-A No. S53-133428, and compounds described in German Patent No. 3337024.

Other Examples of the polymerization initiator include compounds described in F. C. Schaefer et al., J. Org. Chem. 29, 1527 (1964), compounds described in JP-A No. S62-58241, compounds described in JP-A No. H05-281728, compounds described in German Patent No. 2641100, compounds described in German Patent No. 3333450, compounds described in German Patent No. 3021590, and compounds described in German Patent No. 3021599.

Preferred examples of the compounds represented by (a) to (j) are shown below.

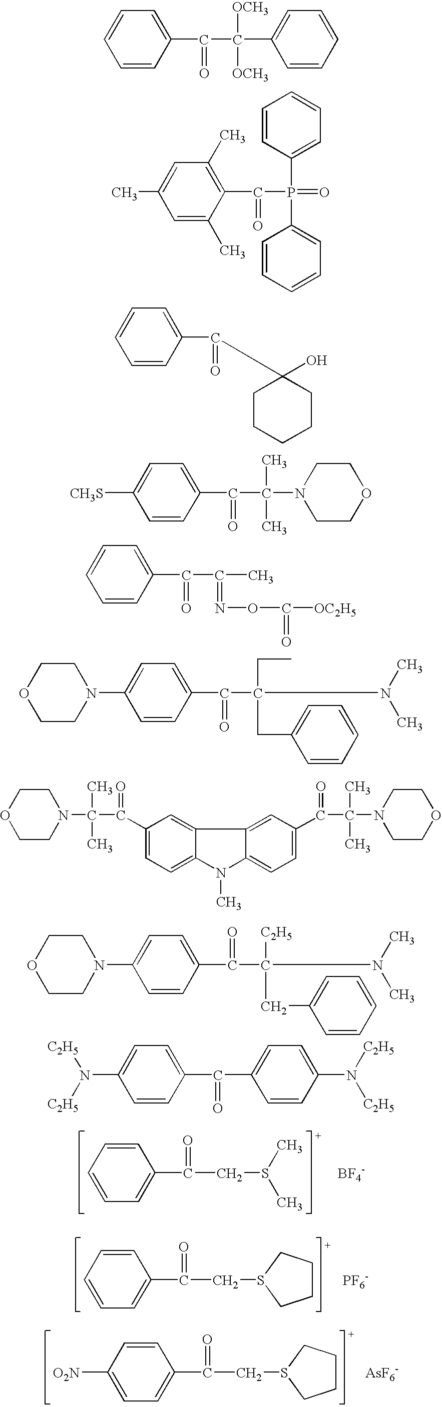

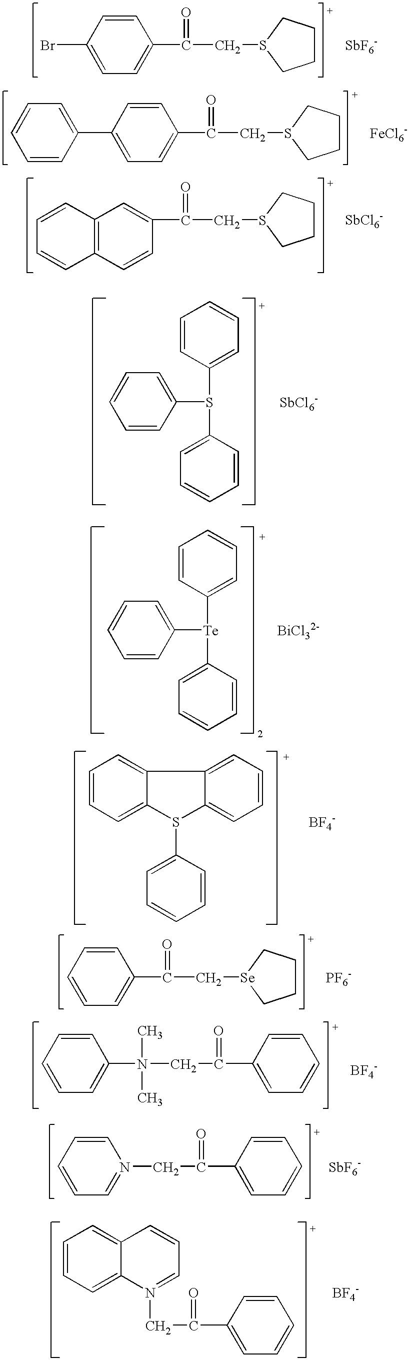

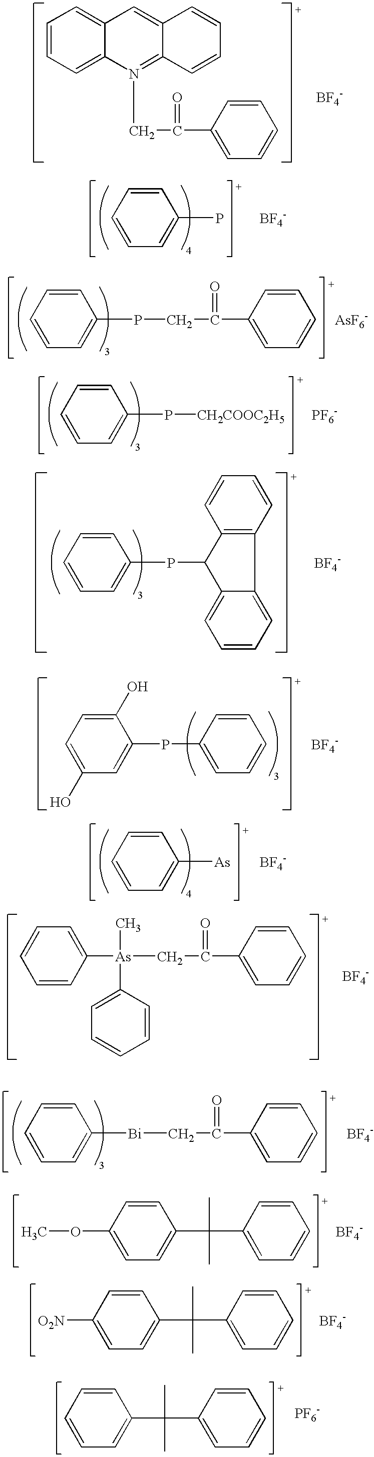

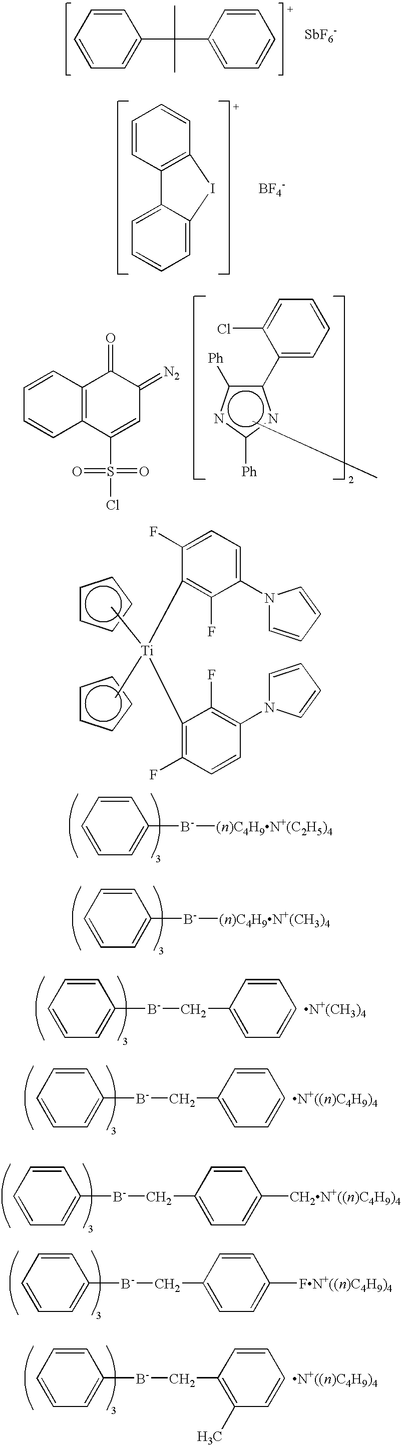

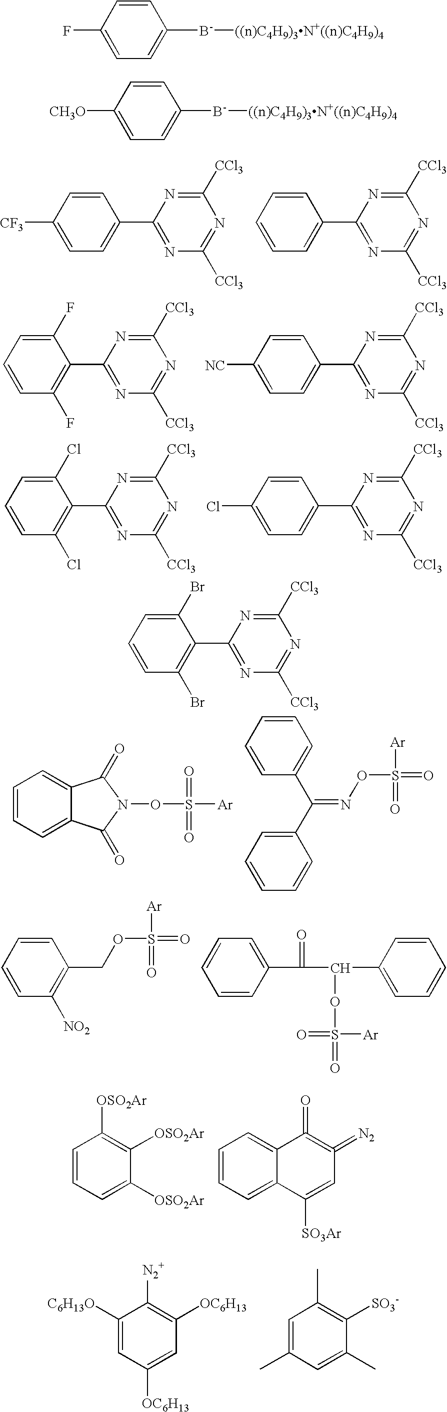

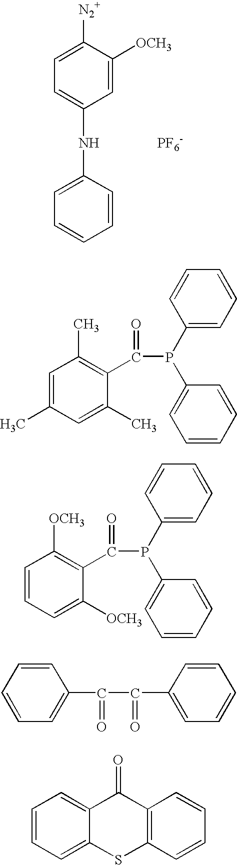

In the ink composition, the content of the polymerization initiator is preferably in the range of 0.5 to 20 mass %, and more preferably in the range of 1 to 12 mass % with respect to the total amount of the metal-containing polymerizable compound(s), the polymerizable compound(s) and the polymerization initiator(s). The content within the above range is effective in raising curing speed, giving good curability, and recording a rigid image, which is resistant to scratch.

### —Colorant—

The ink composition of the invention may contain at least one colorant to form a visible image. The type of the colorant is not particularly limited, and the colorant may be selected properly from various known colorants (particularly, pigments and dyes) according to the application of the ink composition. The invention is effective in increasing printing density, particularly when the colorant is a dye. Examples of the dye include water- and oil-soluble dyes. The dye is preferably an oil-soluble dye in the invention. Hereinafter, the dyes and pigments will be mainly described in details.

### Dye

The dye can be properly selected from known dyes. Typical examples thereof include dyes described in JP-A No. 2002-114930, paragraph Nos. [0023] to [0089].

The dye may be a yellow dye. Examples of the yellow dye include aryl- and heteryl-azo dyes including, as a coupling component, at least one of phenols, naphtols, anilines, pyrazolones, pyridones, and closed ring-type active methylene moieties; azomethin dyes including, as a coupling component, a closed ring-type active methylene moiety; methin dyes such as benzylidene dyes and monomethin oxonol dyes, quinone dyes such as naphthoquinone dyes and anthraquinone dyes; quinophthalone dyes; nitro and nitroso dyes; acridine dyes; and acridinone dyes.

The dye may be a magenta dye. Examples of the magenta dye include aryl- and heteryl-azo dyes including, as a coupling component, at least one of phenols, naphthols, anilines, pyrazolones, pyridones, pyrazolotriazoles, closed ring-type active methylene compounds (for example, dimedone, barbituric acid, and 4-hydroxycoumarin derivatives), and heterocyclic rings having excess electrons (for example, pyrrole, imidazole, thiophene, and thiazole derivatives); azomethin dyes including, as a coupling component, at least one of pyrazolones and pyrazolotriazols; methin dyes such as alylidene dyes, styryl dyes, melocyanine dyes, and oxonol dyes; carbonium dyes such as diphenylmetane dyes, triphenylmetane dyes, and xanthene dyes; quinone dyes such as naphtoquinone, anthraquinone, and anthrapyridone; and condensed polycyclic dyes such as dioxazine dyes.

The dye may be a cyan dye. Examples of the cyan dye include azomethin dyes such as indoaniline dyes and indophenol dyes; polymethin dyes such as cyanine dyes, oxonol dyes and melocyanine dyes; carbonium dyes such as diphenylmethane dyes, triphenylmethane dyes, and xanthene dyes; phthalocyanine dyes; anthraquinone dyes; aryl- and heteryl-azo dyes including, as a coupling component, at least one of phenols, naphthols, anilines, pyrrolopyrimidin-one, and pyrrolotriazin-one derivatives; and indigo and thioindigo dyes.

The abovementioned dyes may form color of yellow, magenta, or cyan after a part of its chromophore dissociates. In such a case, the dyes may include, as a counter cation, an inorganic cation such as alkali metal or ammonium, an organic cation such as pyridinium or a quaternary ammonium salt, or a cationic polymer having, as a partial structure, at least one of the above cations.

As described above, an oil-soluble dye is preferably as the dye in the invention. The term “oil-soluble” specifically means having solubility in water (mass of a colorant soluble in 100 g of water) of 1 g or less at 25° C. The solubility of the oil-soluble dye in water is preferably 0.5 g or less, and more preferably 0.1 g or less at 25° C. Thus, a so-called water-insoluble oil-soluble dye is preferably used as the dye in the invention.

The dye in the invention may be prepared by introducing, into the nucleus structure of the aforementioned dye, at least one group which makes the dye soluble in oil so as to enable dissolution of a necessary amount of the dye in the ink composition.

Examples of such a group include long-chain or branched alkyl groups, long-chain or branched alkoxy groups, long-chain or branched alkylthio groups, long-chain or branched alkylsulfonyl groups, long-chain or branched acyloxy groups, long-chain or branched alkoxycarbonyl groups, long-chain or branched acyl groups, long-chain or branched acylamino groups, long-chain or branched alkylsulfonylamino groups, long-chain or branched alkylaminosulfonyl group, and aryl groups, aryloxy groups, aryloxycarbonyl groups, arylcarbonyloxy groups, arylaminocarbonyl groups, arylaminosulfonyl groups, and arylsulfonylamino groups containing one or more of the above long-chain or branched groups.

The dye may also be prepared as follows. A water-soluble dye having at least one of carboxylic and sulfonic groups is provided, and a part or all of the at least one of carboxylic and sulfonic groups is converted into at least one group which makes the dye soluble in oil, such as an alkoxycarbonyl group, an aryloxycarbonyl group, an alkylaminosulfonyl group, or an arylaminosulfonyl group, with long-chain or branched alcohol, amine, phenol, or aniline derivative.

The melting point of the oil-soluble dye is preferably 200° C. or lower, more preferably 150° C. or lower, and still more preferably 100° C. or lower. Use of such an oil-soluble dye having a low melting point is effective in preventing precipitation thereof in the ink composition and improving the storage stability of the ink composition.

The oil-soluble dye preferably has a high oxidation potential to suppress discoloration thereof, particularly improve resistance to oxidative substances such as ozone, and improve the curing property of the dye. Specifically, the oil-soluble dye preferably has an oxidation potential of more than 1.0 V (vs. SCE). A higher oxidation potential is more preferable, and the oxidation potential of the dye is more preferably 1.1 V or more (vs SCE), and still more preferably 1.15 V or more (vs SCE).

The yellow dye is preferably a compound having a structure represented by Formula (Y-I) described in JP-A No. 2004-250483.

The yellow dye is more preferably a dye represented by any one of Formulae (Y-II) to (Y-IV) described in JP-A No. 2004-250483, paragraph No. [0034], concretely any of compounds described in JP-A No. 2004-250483, paragraph Nos. [0060] to [0071]. The dye represented by Formula (Y-I) described therein may be included not only in a yellow ink but also in an ink having any other color such as black and red.

The magenta dye is preferably a compound having a structure represented by Formula (3) or (4) described in JP-A No. 2002-114930. Specific examples thereof include compounds described in JP-A No. 2002-114930, paragraph Nos. [0054] to [0073].

The magenta dye is more preferably an azo dye represented by Formula (M-1) or (M-2) described in JP-A No. 2002-121414, paragraph Nos. [0084] to [0122]. Specific examples thereof include compounds described in JP-A No. 2002-121414, paragraph Nos. [0123] to [0132]. The oil-soluble dye represented by Formulae (3), (4), (M-1) or (M-2) described in the document may be contained not only in a magenta ink but also in an ink having any other color such as a black ink or a red ink.

The cyan dye is preferably a dye represented by any one of Formulae (I) to (IV) described in JP-A No. 2001-181547, or a dye represented by any one of Formulae (IV-1) to (IV-4) described in JP-A No. 2002-121414, paragraph Nos. [0063] to [0078]. Specific examples thereof include compounds described in JP-A No. 2001-181547, paragraph Nos. [0052] to [0066], and those described in JP-A No. 2002-121414, paragraph Nos. [0079] to [0081].

The cyan dye is more preferably a phthalocyanine dye represented by Formula (C-I) or (C-II) described in JP-A No. 2002-121414, paragraph Nos. [0133] to [0196], and still more preferably a phthalocyanine dye represented by Formula (C-II). Specific examples thereof include compounds described in JP-A No. 2002-121414, paragraph Nos. [0198] to [0201]. The oil-soluble dye represented by any of Formulae (I) to (IV), (IV-1) to (IV-4), (C-I), and (C-II) may be contained not only in a cyan ink but also in an ink having any other color such as a black ink or a green ink.

### —Oxidation Potential—

The oxidation potential (Eox) of the dye in the invention can be easily measured by a person skilled in the art. A method for measuring the oxidation potential is described in, for example, P. Delahay, “New Instrumental Methods in Electrochemistry” (1954, Interscience Publishers), A. J. Bard et al., “Electrochemical Methods” (1980, John Wiley & Sons), and Akira Fujishima et al., “Electrochemical Measurement Methods” (1984, Gihodo Shuppan).

Specifically, the oxidation potential is measured as follows. A test sample is dissolved at a concentration of 1×10⁻² to 1×10⁻⁶ mole/liter in a solvent, such as dimethylformamide or acetonitrile, containing a supporting electrolyte, such as sodium perchlorate or tetrapropylammonium perchlorate. A voltammeter is prepared, and carbon (GC) is used as a working electrode, and a revolving platinum electrode is used as a counter electrode, and sweeping is conducted toward the oxidization side (noble side) to obtain an oxidation wave. Straight line approximation of the oxidation wave is conducted. A line segment is defined by the intersection of the resultant straight line and a residual current-potential line and the intersection of the straight line and a saturated current line (or an intersection of the straight line and a straight line which includes a peak electric potential value and which is in parallel with a vertical axis). The intermediate electric potential value of the line segment is regarded as a voltage with respect to SCE (saturated calomel electrode). The value may change to an extent of approximately several ten millivolts under the influence of the difference between the electric potentials of liquids and the resistance of the sample solution. However, using a standard sample (e.g., hydroquinone) can assure reproducibility of the electric potential. The types of the supporting electrolyte and the solvent may be selected properly according to the oxidation potential and solubility of the test sample. Examples of the supporting electrolyte and the solvent are described in Akira Fujishima et al., “Electrochemical Measurement Methods” (1984, Gihodo Shuppan), pp. 101 to 118. An oxidation potential in a non-association state is measured in the aforementioned concentration range of a phthalocyanine compound sample in the above measurement solvent.

The value Eox shows the degree of easiness in which electrons are transferred from a sample to an electrode. The greater the value Eox is (the higher the oxidation potential is), the less easily electrons are transferred from a sample to an electrode (the less easily the sample is oxidized.

Typical examples of the dye for use in the invention are shown below. However, the invention is not restricted by these examples. Some structures include a wavy line, and the wavy line is a site at which a functional group is bonded to an aromatic ring.

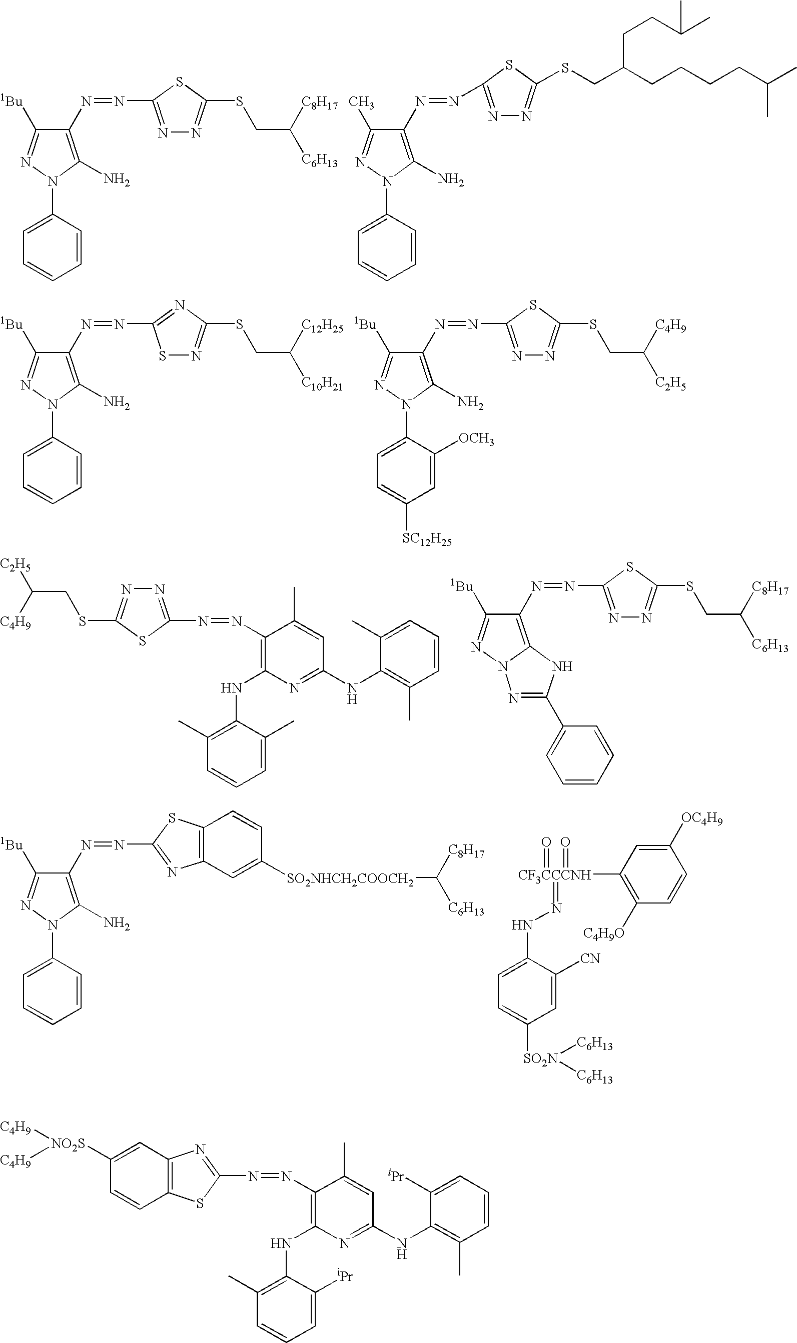

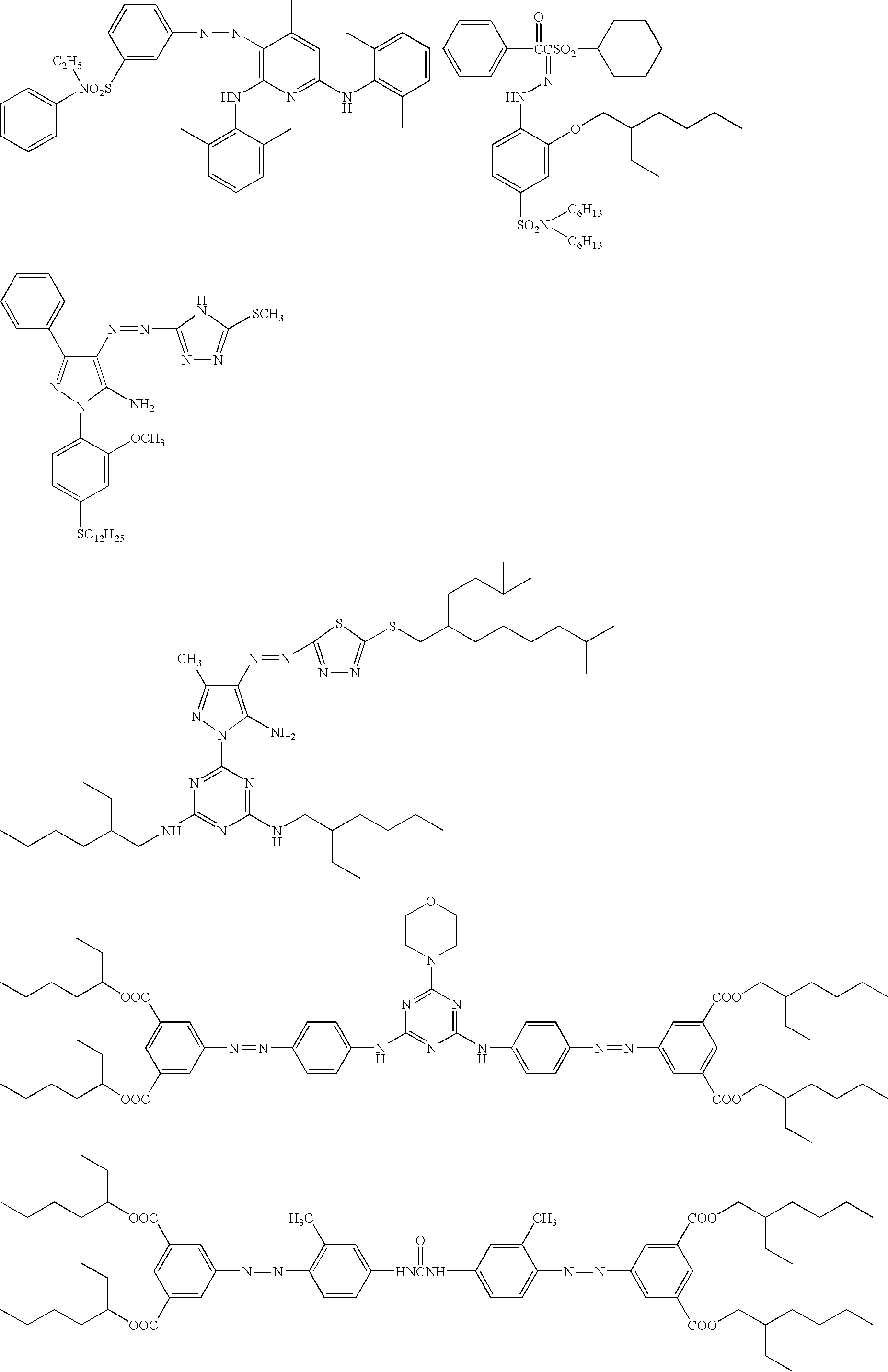

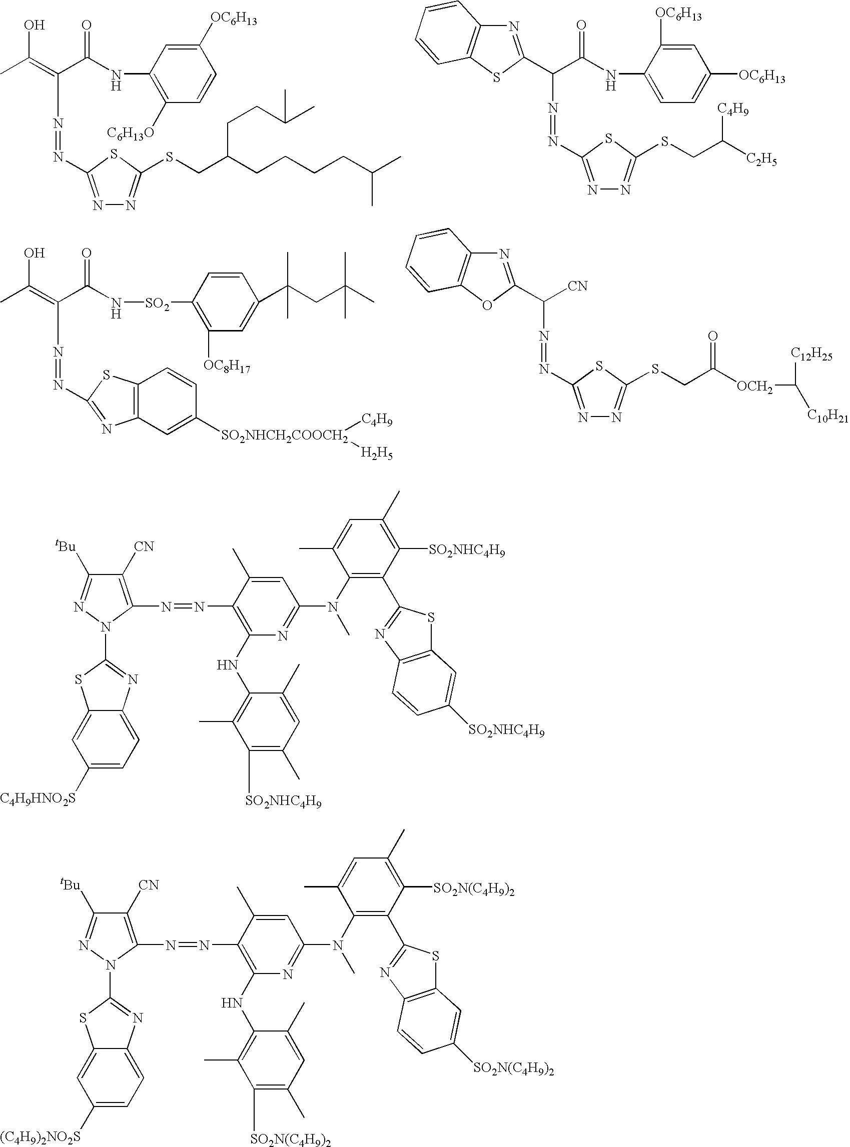

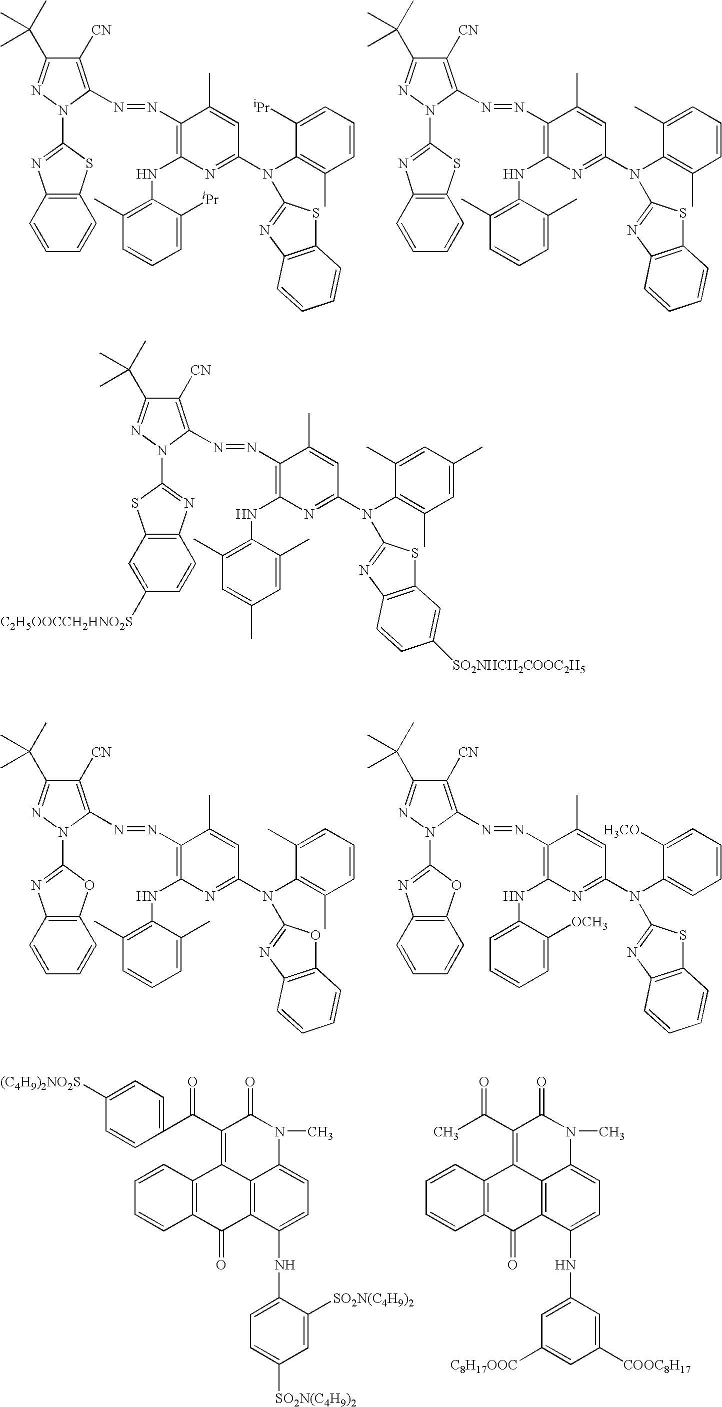

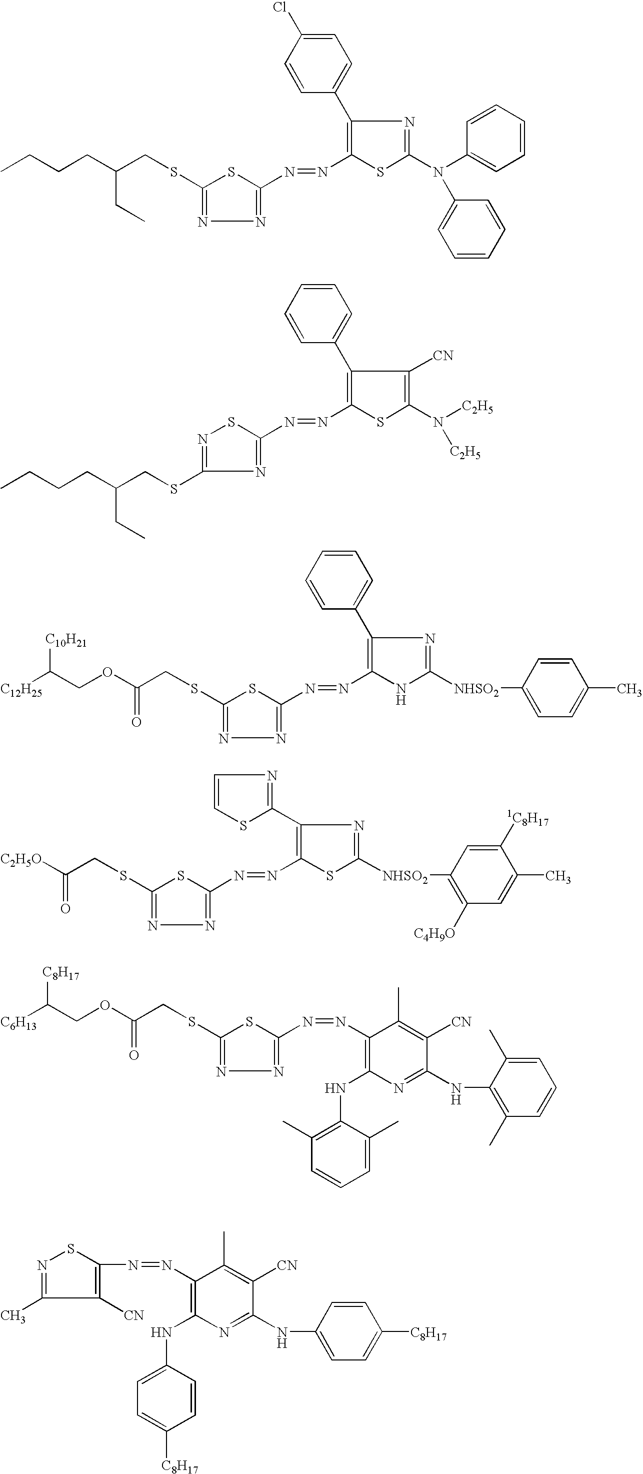

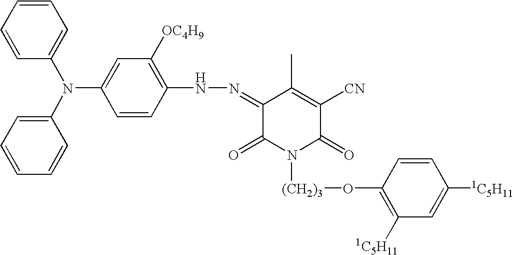

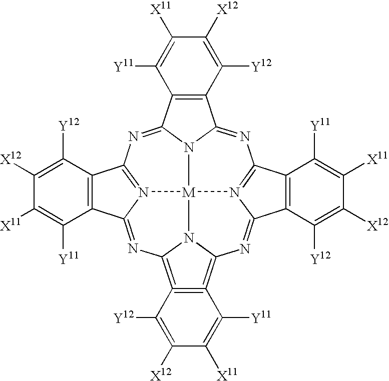

| No. | M | X¹¹ | X¹² | Y¹¹, Y¹² |
|---|---|---|---|---|
| C-1 | Cu | 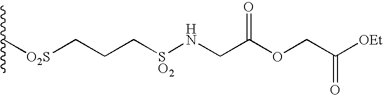 | H | H, H |
| C-2 | Cu | 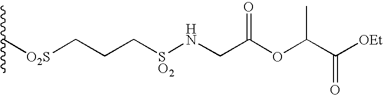 | H | H, H |
| C-3 | Cu | 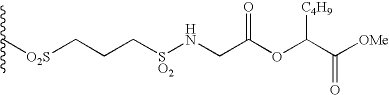 | H | H, H |
| C-4 | Cu | 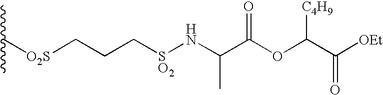 | H | H, H |
| C-5 | Cu | 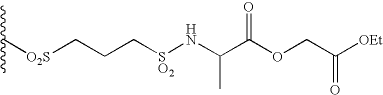 | H | H, H |
| C-6 | Cu | 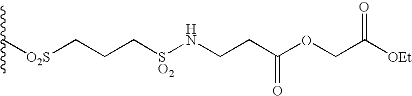 | H | H, H |
| C-7 | Cu | 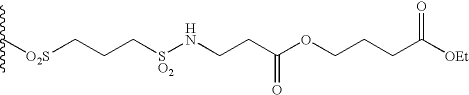 | H | H, H |
| C-8 | Cu | 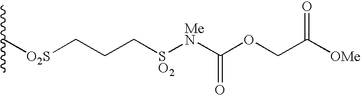 | H | H, H |

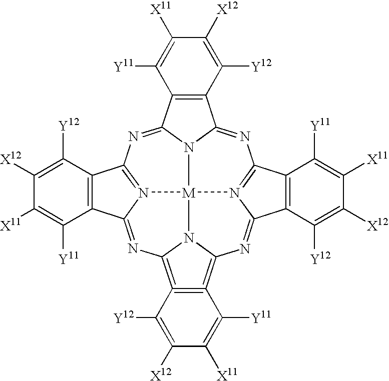

| No. | M | X¹¹ | X¹² | Y¹¹, Y¹² |
|---|---|---|---|---|
| C-9 | Cu | 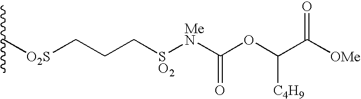 | H | H, H |
| C-10 | Cu | 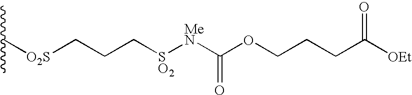 | H | H, H |
| C-11 | Cu | 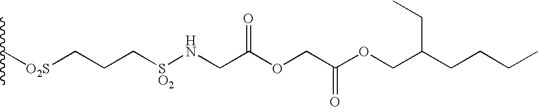 | H | H, H |
| C-12 | Cu | 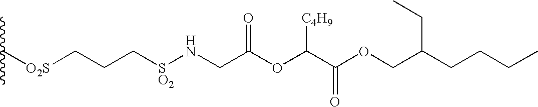 | H | H, H |
| C-13 | Cu | 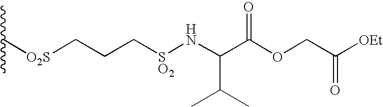 | H | H, H |
| C-14 | Cu | 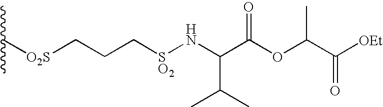 | H | H, H |
| C-15 | Cu | 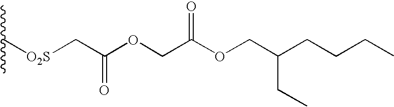 | H | H, H |
| C-16 | Cu | 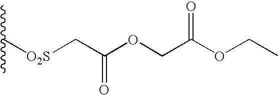 | H | H, H |

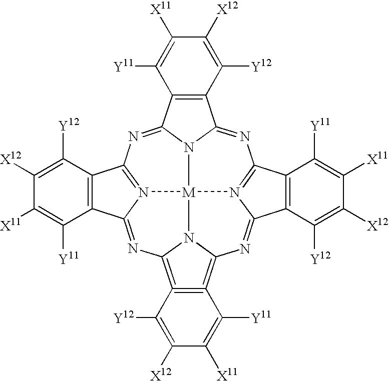

| No. | M | X¹¹ | X¹² | Y¹¹, Y¹² |
|---|---|---|---|---|
| C-17 | Cu | 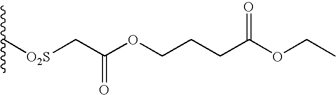 | H | H, H |
| C-18 | Cu | 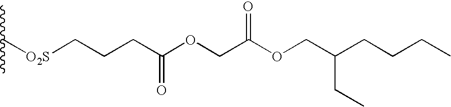 | H | H, H |
| C-19 | Cu | 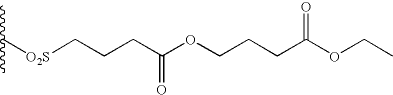 | H | H, H |
| C-20 | Cu | 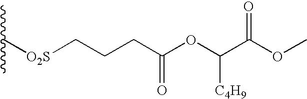 | H | H, H |
| C-21 | Cu | 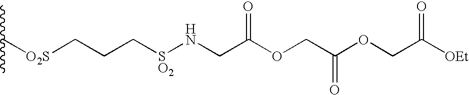 | H | H, H |
| C-22 | Cu | 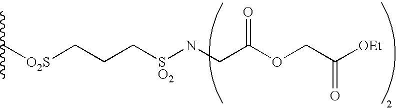 | H | H, H |
| C-23 | Cu | 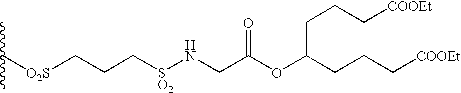 | H | H, H |

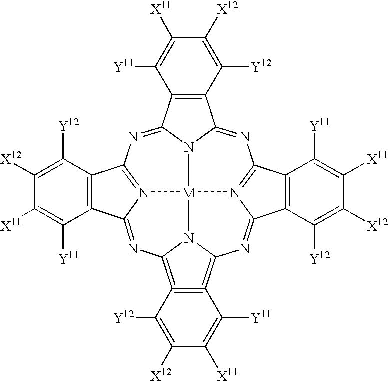

| No. | M | X¹¹ | X¹² | Y¹¹, Y¹² |
|---|---|---|---|---|
| C-24 | Cu | 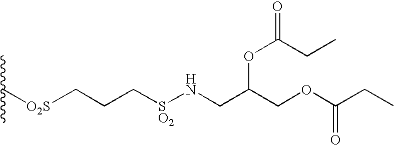 | H | H, H |
| C-25 | Cu | 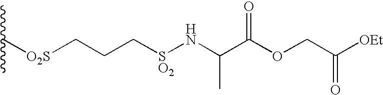 | H | H, Cl |
| C-26 | Cu | 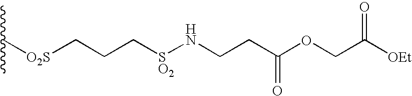 | H | H, Cl |
| C-27 | Cu | 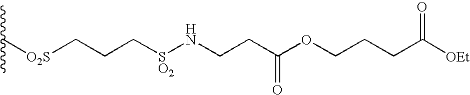 | H | H, Cl |
| C-28 | Cu | 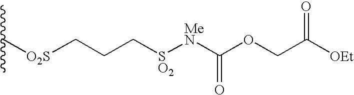 | H | H, Cl |
| C-29 | Cu | 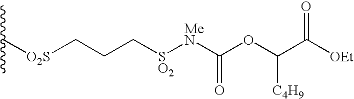 | H | H, Cl |
| C-30 | Cu | 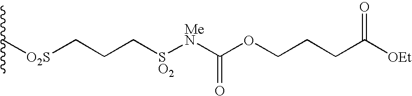 | H | H, Cl |

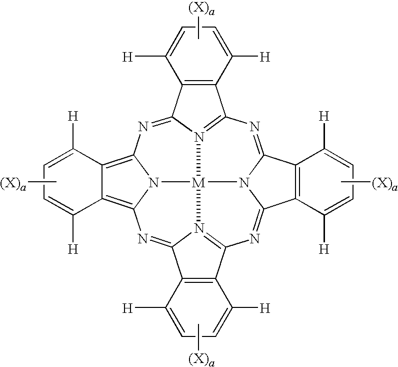

| No. | M | X | a |
|---|---|---|---|
| C-31 | Cu | 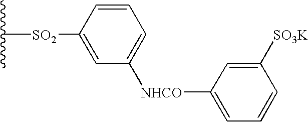 | 1 |
| C-32 | Cu | 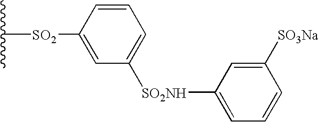 | 1 |
| C-33 | Cu | 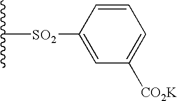 | 1 |
| C-34 | Ni | 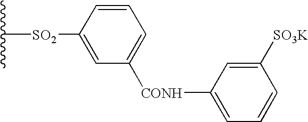 | 1 |
| C-35 | Cu | 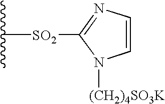 | 1 |
| C-36 | Cu | 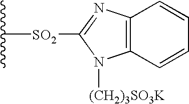 | 1 |
| C-37 | Cu | 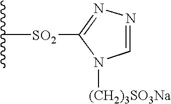 | 1 |
| C-38 | Cu | 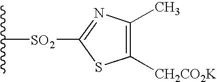 | 1 |

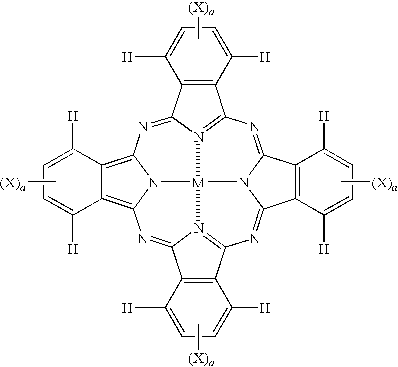

| No. | M | X | a |
|---|---|---|---|
| C-47 | Zn | 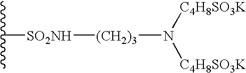 | 1 |
| C-48 | Cu | 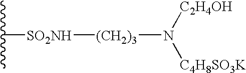 | 1 |
| C-49 | Cu | 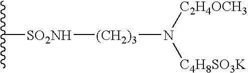 | 1 |
| C-50 | Cu | 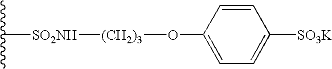 | 1 |

### <Pigment>

Hereinafter, the pigment for use in the invention will be described in detail. The type of the pigment is not particularly limited. The pigment may be any commercially available organic or inorganic pigment, dispersion in which a pigment is dispersed in a dispersion medium such as an insoluble resin, or pigment on the surface of which a resin is grafted. Alternatively, resin particles colored with a dye may also be used as such.

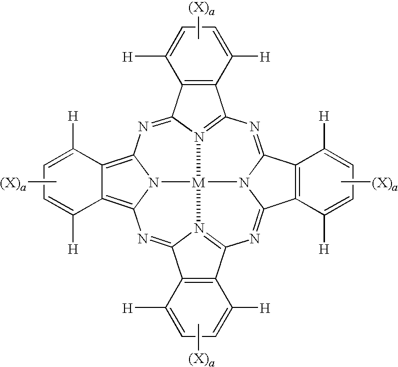

| No. | M | X | a |
|---|---|---|---|
| C-39 | Cu | 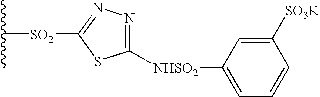 | 1 |
| C-40 | Cu | 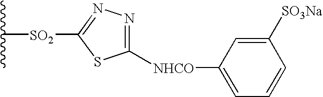 | 1 |
| C-41 | Cu | 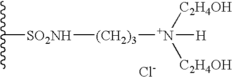 | 1 |
| C-42 | Cu | 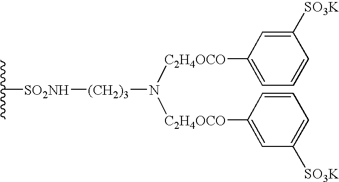 | 1 |
| C-43 | Cu | 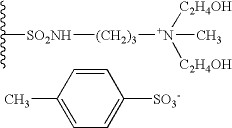 | 1 |
| C-44 | Cu | 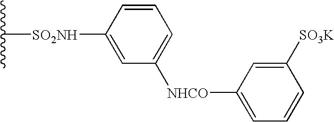 | 1 |
| C-45 | Cu | 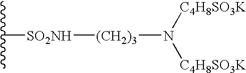 | 1 |
| C-46 | Ni | 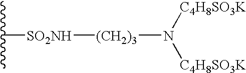 | 1 |

Examples of the pigment are described in, for example, Seijiro Itoh (editor), “Dictionary of Pigments” (2000), W. Herbst and K. Hunger, “Industrial Organic Pigments”, and JP-A Nos. 2002-12607, 2002-188025, 2003-26978, and 2003-342503.

Typical examples of the organic and inorganic pigments include the followings. Examples of a yellow pigment include monoazo pigments such as C.I. Pigment Yellow 1 (e.g., Fast Yellow G) and C.I. Pigment Yellow 74; disazo pigments such as C.I. Pigment Yellow 12 (e.g., Disazo Yellow AAA) and C.I. Pigment Yellow 17; azo pigments not including benzidine such as C.I. Pigment Yellow 180; azo lake pigments such as C.I. Pigment Yellow 100 (e.g., tartrazine yellow lake); condensed azo pigments such as C.I. Pigment Yellow 95 (e.g., Condensed Azo Yellow GR); acidic dye lake pigments such as C.I. Pigment Yellow 115 (e.g., quinoline yellow lake); basic dye lake pigments such as C.I. Pigment Yellow 18 (e.g., thioflavine lake); anthraquinone pigments such as fravanthrone yellow (Y-24); isoindolinone pigments such as Isoindolinone Yellow 3RLT (Y-110); quinophtharone pigments such as quinophtharone yellow (Y-138), isoindoline pigments such as isoindoline yellow (Y-139); nitroso pigments such as C.I. Pigment Yellow 153 (e.g., nickel nitroso yellow); and metal complex salt azomethine pigments such as C.I. Pigment Yellow 117 (e.g., copper azomethine yellow).

Examples of red and magenta pigments include monoazo pigments such as C.I. Pigment Red 3 (e.g., toluidine red); disazo pigments such as C.I. Pigment Red 38 (e.g., Pyrazolone Red B); azo lake pigments such as C.I. Pigment Red 53:1 (e.g., Lake Red C) and C.I. Pigment Red 57:1 (Brilliant Carmine 6B); condensed azo pigments such as C.I. Pigment Red 144 (e.g., Condensed Azo Red BR); acidic dye lake pigments such as C.I. Pigment Red 174 (e.g., Phloxine B Lake); basic dye lake pigments such as C.I. Pigment Red 81 (e.g., Rhodamine 6G′ Lake); anthraquinone pigments such as C.I. Pigment Red 177 (e.g., dianthraquinonyl red); thioindigo pigments such as C.I. Pigment Red 88 (e.g., Thioindigo Bordeaux); perynone pigments such as C.I. Pigment Red 194 (e.g., perynone red); perylene pigments such as C.I. Pigment Red 149 (e.g., perylene scarlet); quinacridone pigments such as C.I. Pigment Violet 19 (unsubstituted quinacridone) and C.I. Pigment Red 122 (e.g., quinacridone magenta); isoindolinone pigments such as C.I. Pigment Red 180 (e.g., Isoindolinone Red 2BLT); and alizarin lake pigments such as C.I. Pigment Red 83 (e.g., madder lake).

Examples of blue and cyan pigments include disazo pigments such as C.I. Pigment Blue 25 (e.g., dianisidine blue), phthalocyanine pigments such as C.I. Pigment Blue 15 (e.g., phthalocyanine blue); acidic dye lake pigments such as C.I. Pigment Blue 24 (e.g., peacock blue lake); basic dye lake pigments such as C.I. Pigment Blue 1 (e.g., Victria Blue BO lake); anthraquinone pigments such as C.I. Pigment Blue 60 (e.g., indanthron blue); and alkali blue pigments such as C.I. Pigment Blue 18 (Alkali Blue V-5:1).

Examples of green pigments include phthalocyanine pigments such as C.I. Pigment Green 7 (phthalocyanine green) and C.I. Pigment Green 36 (phthalocyanine green); and azo metal complex pigments such as C.I. Pigment Green 8 (nitroso green).

Examples of orange pigments include isoindoline pigments such as C.I. Pigment Orange 66 (isoindoline orange); and anthraquinone pigments such as C.I. Pigment Orange 51 (dichloropyranthron orange).

Examples of black pigments include carbon black, titanium black, and aniline black.

Examples of white pigments include basic lead carbonate (2PbCO₃Pb(OH)₂, so-called silver white), zinc oxide (ZnO, so-called zinc white), titanium oxide (TiO₂, so-called titanium white), and strontium titanate (SrTiO₃, so-called titanium strontium white).

Titanium oxide has a lower density and a higher refractive index than any other white pigment. Also, titanium oxide is stable chemically or physically. Thus, it has greater covering power and tinting strength, and excellent resistance to acid and alkali and other environmental factors. Therefore, the white pigment is preferably titanium oxide. However, the ink composition of the invention may include other white pigment(s) (including white pigments other than those described above), as needed.

The pigment may be used in the form of a dispersion obtained by dispersing it and an optional dispersant in a dispersion medium. Any dispersing machine, such as a ball mill, a sand mill, an attritor, a roll mill, a jet mill, a homogenizer, a paint shaker, a kneader, a agitator, a Henschel mixer, a colloid mill, an ultrasonic wave homogenizer, a pearl mill, or a wet jet mill, may be used in dispersing the pigment.

The ink composition may include at least one dispersant and/or at least one dispersion aid, when the ink composition includes at least one pigment which is dispersed in the ink composition.

Examples of the dispersant include hydroxyl group-containing carboxylic acid esters, salts of long-chain polyaminoamides with high-molecular weight acid esters, high-molecular weight polycarboxylates, high-molecular weight unsaturated acid esters, copolymers, modified polyacrylates, polyvalent aliphatic carboxylic acids, naphthalenesulfonic acid/formalin condensates, polyoxyethylene alkylphosphoric esters, and pigment derivatives. A commercially available polymer dispersant, for example, a product of SOLSPERSE series available from Zeneca, is also preferably used.

The dispersion aid may be a synergist suitable for the pigment used.

The amount of the dispersant(s) and the dispersion aid(s) is preferably in the range of 1 to 50 parts by mass with respect to 100 parts by mass of the pigment(s).

The ink composition may contain at least one solvent as a dispersion medium for the components thereof such as a pigment. Alternatively, when the aforementioned polymerizable compound(s), which is a low-molecular weight component, is also used as the dispersion medium, the ink composition may not include a solvent. Since the ink composition of the invention is a radiation-curable ink that is cured after application of the ink to a recording medium, it is preferable that the ink composition contains no solvent. This is because a solvent remaining in a cured ink image leads to deterioration in solvent resistance of the image and requires a measure concerning volatile organic compounds (VOC). The dispersion medium is preferably the polymerizable compound(s) from these viewpoints, and, from the viewpoint of improvement in dispersibility of the medium and the handling property of the ink composition, is more preferably a polymerizable compound having the lowest viscosity.

The average diameter of the pigment particles is preferably 0.08 to 0.5 μm, more preferably 10 μm or less, and still more preferably 3 μm or less. It is preferable that selection of the types of the pigment(s), the dispersant(s), and/or the dispersion medium(s) and setting of dispersion and/or filtration conditions are so conducted as to attain this. Control of the particle diameter within the above range enables prevention of clogging in head nozzles and preservation of the storage stability, transparency and curing sensitivity of the ink composition.

The colorant is preferably contained in the ink composition in an amount of 0.05 to 20 mass %, and more preferably 0.2 to 10 mass % with respect to the total mass of the ink composition. When an oil-soluble dye is used as the colorant, the content of the colorant is particularly preferably 0.2 to 6 mass % with respect to the total mass of the ink composition.

### —Additives and Others Components—

The ink composition of the invention may contain any additive(s) and/or other component(s) such as a sensitizing dye, a co-sensitizer and an ultraviolet absorbent in combination with the aforementioned components according to the purpose and application of the ink composition. Hereinafter, the additives and other components will be described.

### —Sensitization Colorant—

The ink composition of the invention may contain at least one sensitizing dye for improvement in the sensitivity of the polymerization initiator. Hereinafter, the sensitizing dye will be described.

Examples of the sensitizing dye include those belonging to compounds shown below and having absorption in the wavelength range of 350 nm to 450 nm.

Examples of the sensitizing dye include polynuclear aromatic compounds (e.g., pyrene, perylene, triphenylene, and 2-ethyl-9,10-dimethoxy anthracene), xanthenes (e.g., fluorescein, eosin, erythrocin, rhodamine B, and rose bengal), cyanines (e.g., thiacarbocyanine, and oxacarbocyanine), merocyanines (e.g., merocyanine, and carbomerocyanine), thiazines (e.g., thionine, methylene blue, and toluidine blue), acridines (e.g., acridine orange, chloroflavine, and acriflavine), anthraquinones (e.g., anthraquinone), squaliums (e.g., squalium), and coumarins (e.g., 7-diethylamino-4-methylcoumarin).

In the invention, the sensitizing dye is preferably a compound represented by any of the following Formulae (vi) to (x).

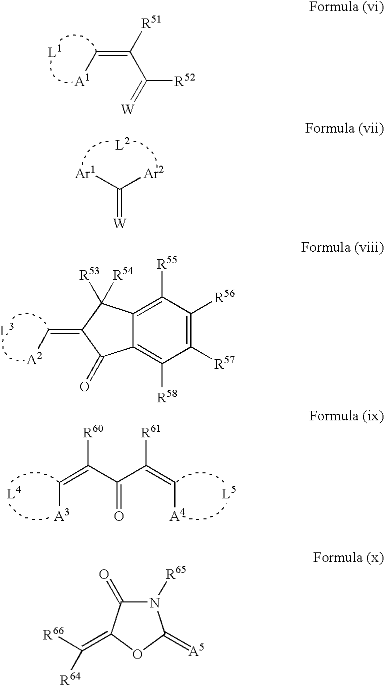

In Formula (vi), A¹ represents a sulfur atom or NR⁵⁰; and R⁵⁰ represents an alkyl or aryl group. L¹ represents a non-metal atomic group which, together with A¹ and the carbon atom both adjacent to L¹, forms the basic nucleus of the dye. R⁵¹ and R⁵² independently represent a hydrogen atom or a monovalent non-metal atomic group, and R⁵¹ and R⁵² may bind to each other to form the acidic nucleus of the dye. W represents an oxygen or sulfur atom.

In Formula (vii), Ar¹ and Ar² independently represent an aryl group, and are connected to each other via L². L² represents —O— or —S—. W has the same meaning as in Formula (vi).

In Formula (viii), A² represents a sulfur atom or NR⁵⁹, and R⁵⁹ represents an alkyl or aryl group. L³ represents a non-metal atomic group which, together with A² and the carbon atom both adjacent to L³, forms the basic nucleus of the dye. R⁵³, R⁵⁴, R⁵⁵, R⁵⁶, R⁵⁷ and R⁵⁸ independently represent a monovalent non-metal atomic group.

In Formula (ix), A³ and A⁴ independently represent —S—, —NR⁶²—, or —NR⁶³—, and R⁶² and R⁶³ independently represent a substituted or unsubstituted alkyl or aryl group. L⁴ and L⁵ independently represent a non-metal atomic group which, together with A³ or A⁴ and the carbon atom both adjacent to L⁴ or L⁵, forms the basic nucleus of the dye. R⁶⁰ and R⁶¹ independently represent a hydrogen atom or a monovalent non-metal atomic group, and R⁶⁰ and R⁶¹ may bind to each other to form an aliphatic or aromatic ring.

In Formula (x), R⁶⁶ represents an aromatic or hetero ring that may have at least one substituent. A⁵ represents an oxygen atom, a sulfur atom or NR⁶⁷—. R⁶⁴, R⁶⁵ and R⁶⁷ independently represent a hydrogen atom or a monovalent non-metal atomic group. R⁶⁷ and R⁶⁴, and/or R⁶⁵ and R⁶⁷ may bind to each other to form an aliphatic or aromatic ring.

Typical examples of the compounds represented by the Formulae (vi) to (x) are shown below. However, the invention is not restricted by these examples.

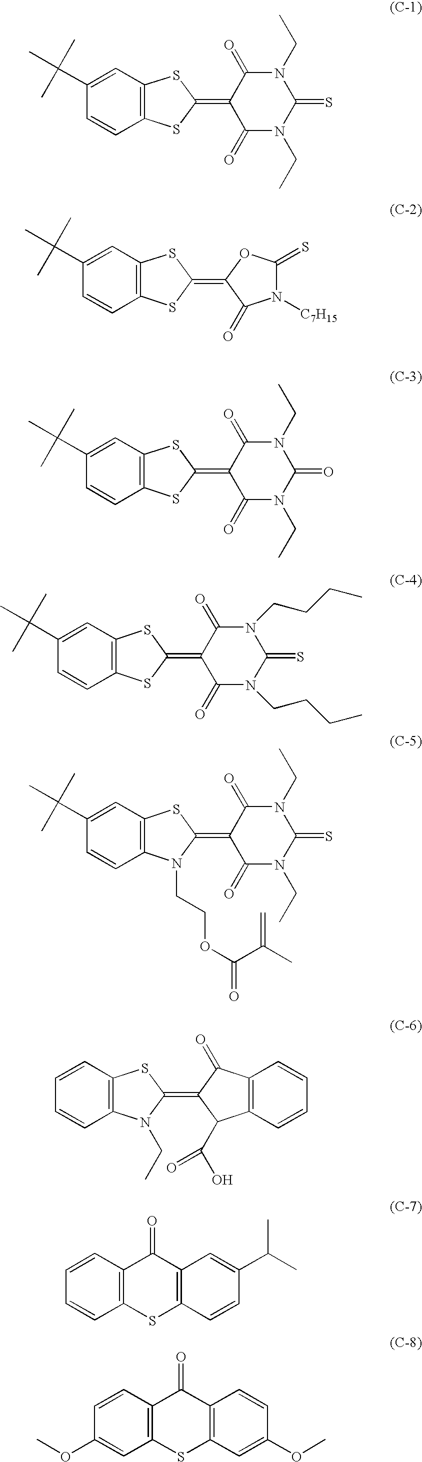

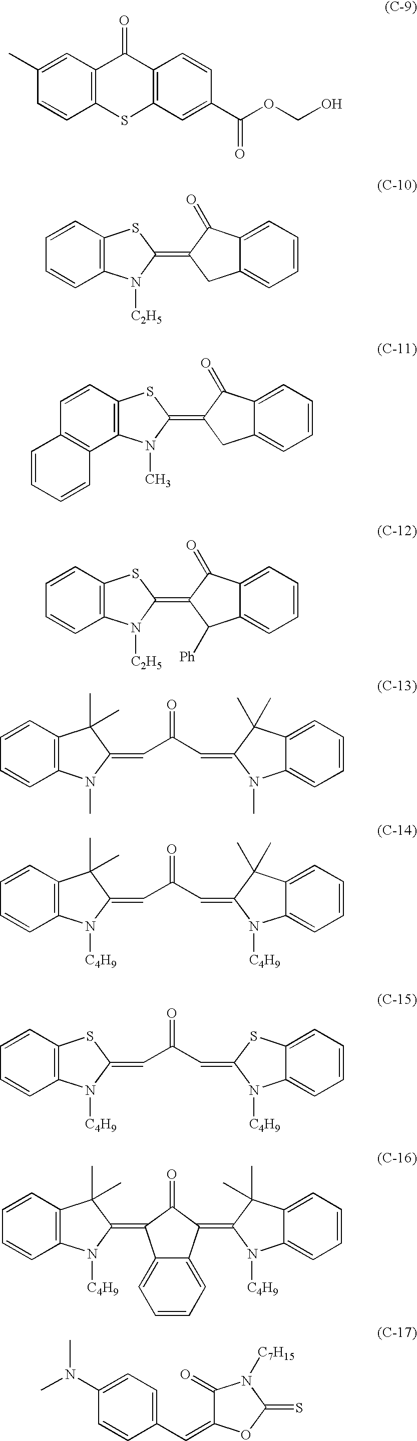

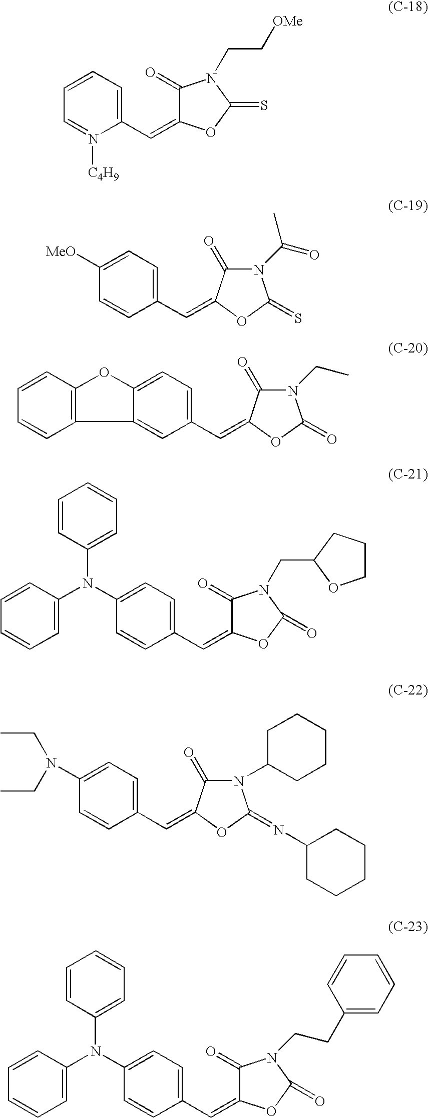

One of these sensitizing dyes may be used alone or two or more of them can be used together.

The content of the sensitizing dye(s) is preferably 0.001 to 20 mass %, more preferably 0.1 to 15 mass %, and still more preferably 0.5 to 10 mass % with respect to the total content (total mass) of the ink composition from the viewpoint of the coloring property of the ink composition. The content ratio (a/c) of the sensitizing dye(s) (a) to the polymerization initiator(s) (c) in the ink composition is preferably 100 to 0.5, more preferably 50 to 1, and still more preferably 10 to 1.5 from the viewpoints of improvement in the decomposition rate of the polymerization initiator(s) and the transmittance with respect to irradiated light.

### —Co-Sensitizer—

The ink composition of the invention may contain at least one co-sensitizer to further improve sensitivity of the ink composition and prevent oxygen from inhibiting polymerization of the polymerizable compound(s). The co-sensitizer may be a known compound.

The co-sensitizer may be an amine compound described in M. R. Sander et al., “Journal of Polymer Society”, vol. 10, page 3173 (1972), JP-B No. S44-20189, JP-A No. S51-82102, S52-134692, S59-138205, S60-84305, S62-18537, or S64-33104, or Research Disclosure 33825. Specific examples thereof include triethanolamine, ethyl p-dimethylaminobenzoate, p-formyldimethylaniline, and p-methylthiodimethylaniline.

The co-sensitizer may also be thiol or sulfide such as a thiol compound described in JP-A No. S53-702, JP-B No. S55-500806, or JP-A No. H05-142772, or a disulfide compound described in JP-A No. S56-75643. Specific examples thereof include 2-mercaptobenzothiazole, 2-mercaptobenzoxazole, 2-mercaptobenzimidazole, 2-mercapto-4(3H)-quinazoline, and β-mercaptonaphthalene.

Alternatively, the co-sensitizer may be an amino acid compound (e.g., N-phenylglycine), an organometal compound (e.g., tributyl tin acetate) described in JP-B No. S48-42965, a hydrogen donor described in JP-B No. S55-34414, a sulfur compound (e.g., trithiane) described in JP-A No. H06-308727, a phosphorus compound (e.g., diethylphosphite) described in JP-A No. H06-250387, an Si—H or Ge—H compound described in JP-A No. H08-65779.

The content of the co-sensitizer(s) is suitably selected according to the intended usage of the ink composition, but is generally about 0.01 to about 10 mass % with respect to the total amount (mass) of the ink composition.

### —Surfactant—

The ink composition of the invention may contain at least one surfactant. The surfactant can be any one of those described in JP-A Nos. S62-173463 and S62-183457. Specific examples thereof include anionic surfactants such as dialkylsulfosuccinates, alkylnaphthalenesulfonates, and fatty acid salts; nonionic surfactants such as polyoxyethylene alkyl ether, polyoxyethylene alkyl allyl ether, acetylenic glycols, and polyoxyethylene/polyoxypropyrene block copolymer; and cationic surfactants such as alkylamine salts, and quaternary ammonium salts. An organic fluoro compound may be used instead of the above surfactant. The organic fluoro compound is preferably hydrophobic. Examples of the organic fluoro compound include fluorine-containing surfactants, oily fluorine-containing compounds (such as fluorine oil), and fluorine-containing solid resins (such as ethylene tetrafluoride resin). The organic fluoro compounds are described in, for example, JP-B No. 957-9053 (columns 8 to 17), and JP-A No. S62-135826.

### —Polymerization Inhibitor—

The ink composition of the invention may contain at least one polymerization inhibitor. The polymerization inhibitor is preferably a phenolic hydroxyl group-containing compound, quinones, an N-oxide compound, a piperidin-1-oxyl free radical compound, a pyrrolidin-1-oxyl free radical compound, N-nitroso phenyl hydroxylamine, or a cationic dye.

Typical examples thereof include hydroquinone, p-methoxyphenol, di-t-butyl-p-cresol, pyrogallol, resorcinol, catechol, t-butyl catechol, hydroquinone monoalkyl ethers (e.g., hydroquinone monomethyl ether, and hydroquinone monobutyl ether), benzoquinone, 4,4-thiobis(3-methyl-6-t-butylphenol), 2,2′-methylene-bis(4-methyl-6-t-butylphenol), 2,2,6,6-tetramethylpiperidine and derivatives thereof, di-t-butyl nitroxide, 2,2,6,6-tetramethylpiperidine-N-oxide and derivatives thereof, piperidin-1-oxyl free-radical, 2,2,6,6-tetramethylpiperidin-1-oxyl free radical, 4-oxo-2,2,6,6-tetramethylpiperidin-1-oxyl free radical, 4-hydroxy-2,2,6,6-tetramethylpiperidin-1-oxyl free radical, 4-acetamido-2,2,6,6-tetramethylpiperidin-1-oxyl free radical, 4-maleimido-2,2,6,6-tetramethylpiperidin-1-oxyl free radical, 4-phosphonoxy-2,2,6,6-tetramethylpiperidin-1-oxyl free radical, 3-carboxy-2,2,5,5-tetramethylpyrrolidin-1-oxyl free radical, N-nitrosophenylhydroxylamine cerous salt, N-nitrosophenylhydroxylamine aluminum salt, crystal violet, methyl violet, ethyl violet, and Victoria Pure Blue BOH.

The polymerization inhibitor is preferably hydroquinone monoalkyl ether such as hydroquinone monomethyl ether or hydroquinone monobutyl ether, or hindered phenol such as 4,4′-thiobis(3-methyl-6-t-butylphenol) or 2,2′-methylenebis(4-methyl-6-t-butylphenol).

The content of the polymerization inhibitor(s) is preferably 10,000 to 30,000 ppm, more preferably 10,000 to 20,000 ppm, and still more preferably 10,000 to 15,000 ppm with respect to the total amount (mass) of the ink composition.

### —Ultraviolet Absorbent—

The ink composition of the invention may contain at least one ultraviolet absorbent to improve weather resistance of an image obtained by curing the ink composition and prevent discoloration of the image.

Examples of the ultraviolet absorbent include benzotriazole compounds described in JP-A Nos. S58-185677, S61-190537, H02-782, H05-197075 and H09-34057; benzophenone compounds described in JP-A Nos. S46-2784 and H05-194483, and U.S. Pat. No. 3,214,463; cinnamic acid compounds described in JP-B Nos. S48-30492 and S56-21141, and JP-A No. H10-88106; triazine compounds described in JP-A Nos. H04-298503, H08-53427, H08-239368, H10-182621 and H08-501291; compounds described in Research Disclosure No. 24239; compounds which absorb ultraviolet rays to emit fluorescence, or so-called fluorescent brighteners, such as stilbene and benzoxazole compounds.

The addition amount of the ultraviolet absorbent is suitably selected according to the application of the ink composition, but is generally about 0.01 to about 10 mass % with respect to the total amount (mass) of the ink composition.

### —Antioxidant—

The ink composition of the invention may contain at least one antioxidant in order to improve stability of the ink composition. Examples of the antioxidant include those described in EP-A Nos. 223739, 309401, 309402, 310551, 310552, and 459-416, German Patent Publication No. 3435443, JP-A Nos. S54-48535, S62-262047, S63-113536, S63-163351, H02-262654, H02-71262, H03-121449, H05-61166, and H05-119449, and U.S. Pat. Nos. 4,814,262, and 4,980,275.

The content of the antioxidant(s) is suitably selected according to the intended usage of the ink composition, but is generally about 0.01 to about 10 mass % with respect to the total amount (mass) of the ink composition.

### —Discoloration Inhibitor—

The ink composition of the invention may contain at least one discoloration inhibitor. The discoloration inhibitor may be any organic or metal complex compound. Examples of the organic discoloration inhibitor include hydroquinones, alkoxyphenols, dialkoxyphenols, phenols, anilines, amines, indans, chromans, alkoxyanilines, and heterocycles. Examples of the metal complex compound include nickel complexes and Zinc complexes. Specific examples of these complexes include compounds disclosed in cited patents described in Sections I and J of Chapter VII of Research Disclosure No. 17643, Research Disclosure No. 15162, the left column of page 650 of Research Disclosure No. 18716, page 527 of Research Disclosure No. 36544, page 872 of Research Disclosure No. 307105, and Research Disclosure No. 15162, and compounds included in the scope of formulae of typical compounds and examples of the typical compounds described in page 127 to 137 of JP-A No. S62-215272.

The content of the discoloration inhibitor(s) is suitably selected according to the intended usage of the ink composition, but is generally about 0.01 to about 10 mass % with respect to the total amount (mass) of the ink composition.

### —Electrically Conductive Salt—

The ink composition of the invention may contain at least one electrically conductive salt to control the ejecting property of the ink composition. The electrically conductive salt may be potassium thiocyanate, lithium nitrate, ammonium thiocyanate, or dimethylamine hydrochloride.

### —Solvent—

Inclusion of an extremely trace amount of at least one organic solvent in the ink composition of the invention is effective in improving adhesiveness of the ink composition to a recording medium. Examples of the solvent include ketone solvents such as acetone, methyl ethyl ketone, and diethyl ketone; alcohol solvents such as methanol, ethanol, 2-propanol, 1-propanol, 1-butanol, and tert-butanol; chlorinated solvents such as chloroform and methylene chloride; aromatic solvents such as benzene and toluene; ester solvents such as ethyl acetate, butyl acetate, and isopropyl acetate; ether solvents such as diethyl ether, tetrahydrofuran, and dioxane; and glycol ether solvents such as ethylene glycol monomethyl ether and ethylene glycol dimethyl ether.

In such a case, the content of the solvent(s) contained is in such a range that the solvent(s) does not deteriorate solvent resistance of a formed image and does not require a measure concerning VOC. Thus, the content of the solvent(s) in the ink composition is preferably in the range of 0.1 to 5 mass %, and more preferably in the range of 0.1 to 3 mass %.

### —Polymer Compound—

The ink composition of the invention may contain at least one polymer compound to control the physical properties of a formed film (image).

Examples of the polymer compound include acrylic polymers, polyvinyl butyral resins, polyurethane resins, polyamide resins, polyester resins, epoxy resins, phenol resins, polycarbonate resins, polyvinyl formal resins, shellac, vinyl resins, acrylic resins, rubber resin, waxes, and other natural resins. Two or more of these resins may be used together.

Among these compounds, the polymer compound is preferably vinyl copolymer obtained by copolymerizing at least one acrylic monomer and other monomer(s). The polymer compound is also preferably copolymer whose monomers contain at least one of a “carboxyl group-containing monomer”, “alkyl methacrylate”, and “alkyl acrylate”.

The ink composition of the invention may contain other additive(s), such as a leveling additive, a matting agent, wax, polyolefin, or a tackifier which does not inhibit polymerization. Wax and/or polyolefin are contained to control the physical properties of a formed film (image). The tackifier is contained to improve adhesiveness of the ink composition to a recording media made of, for example, PET.

Typical examples of the tackifier include high-molecular weight adhesive polymers described in IP-A No. 2001-49200, p. 5 to 6 (e.g., copolymers obtained by copolymerizing an ester of (meth)acrylic acid and alcohol which contains an alkyl group having 1 to 20 carbon atoms, an ester of (meth)acrylic acid and alicyclic alcohol having 3 to 14 carbon atoms, and an ester of (meth)acrylic acid and aromatic alcohol having 6 to 14 carbon atoms), and low-molecular-weight adhesive resins containing polymerizable unsaturated bonds.

### Preferred Physical Properties of Ink Composition

When used in ink jet recording, the ink composition of the invention preferably has an ink viscosity of 5 to 30 mPa·s, and more preferably 7 to 20 mPa·s at an ejection temperature from the viewpoint of the ejecting property of the ink composition. Thus, the composition rate of the ink composition is preferably so determined and adjusted that the viscosity of the ink composition falls within the above range.

The viscosity of the ink composition is preferably 7 to 120 mPa·s and more preferably 10 to 80 mPa·s at room temperature (25° C.). Even when a recording medium is porous, the ink composition having an increased viscosity at room temperature can be prevented from penetrating the recording medium, can result in a reduced amount of monomers which have not been cured, and a reduced level of odor, can suppress bleeding of ink dots obtained by arrival of ink droplets on the recording medium, and consequently can improve image quality.

The surface tension of the ink composition of the invention is preferably 20 to 40 mN/m and more preferably 20 to 30 mN/m.

When the ink composition of the invention is used to record images on various recording media such as a polyolefin or PET sheet, coated paper, or non-coated paper, the surface tension is preferably 20 mN/m or more for prevention of ink bleeding and penetration, and 30 mN/m or less for improvement in the wetting property of the ink composition.

The ink composition of the invention is preferably used as an ink-jet recording ink. The inkjet-recording method is not particularly limited, and may be, for example, an electric charge-controlling method for ejecting ink by using electrostatic attractive force, a drop-on-demand method (pressure pulse method) using the vibrational pressure of a piezo element or elements, an acoustic ink-jetting method for ejecting ink due to radiation pressure generated by converting electrical signals into acoustic beams and applying the beams to the ink, or a thermal ink-jetting method for ejecting ink due to pressure generated by heating the ink and forming air bubbles therein. The ink-jet recording methods includes those for ejecting multi droplets of a so-called photo ink, which has a low concentration, having a small volume, those using plural inks that have substantially the same color tone and different concentrations to improve image quality, and those using a transparent and colorless ink.

Among these methods, the ink composition of the invention is preferably used in a drop-on-demand ink-jet recording method (pressure pulse method) using a piezo element or elements. The ink composition of the invention can also be used as ink for printing other than such ink-jet recording.

### <Image-Forming Method>

The ink composition of the invention can be used in the image-forming method of the invention. The image-forming method includes ejecting the ink composition in accordance with an ink-jet recording manner to record an image on a recording medium, or includes recording an image on a recording medium by using the ink composition and irradiating the image recorded on the recording medium with active energy rays to cure the image.

In other words, the image-forming method of the invention may include only formation of an image in accordance with an ink-jet recording manner or may include such formation and curing of the image. Alternatively, the method may include formation of an image in a manner other than ink-jet recording and curing of the image.

In the curing, active energy rays are used. Irradiating the image recorded on a recording medium with active energy rays progresses polymerization and curing of the polymerizable compounds, which contribute to formation of an image, and, therefore, the polymerizable compounds are sufficiently cured to provide a rigid image.

In the image recording, ink-jet recording manner and printer are preferably used. Specifically, an ink image is preferably formed in such an ink-jet recording manner that the ink composition is ejected with, for example, the ejection nozzle(s) of an ink-jet printer in the image recording. In the ink-jet recording manner, the ink composition of the invention is used to record an image on a recording medium. The type of the ink ejection nozzle of the ink-jet printer used in the manner is not particularly limited. The ink ejection nozzle may be selected properly according to purposes and applications. The ink-jet recording method is not particularly limited, and examples thereof are already described.

In the curing, exposure treatment can be conducted in which a light source that emits active energy rays having a wavelength in the wavelength range to which the ink composition is sensitive is used to accelerate the polymerization and curing of the ink composition. The light source preferably emits active energy rays having a wavelength of 250 to 450 mm, and such a light source is, for example, an LD, an LED, a fluorescent lamp, a low-pressure mercury lamp, a high-pressure mercury lamp, a metal halide lamp, a carbon arc lamp, a xenon lamp, or a chemical lamp. The light source is preferably an LED, a high-pressure mercury lamp, or a metal halide lamp. The exposure time and the light exposure may be properly selected according to a desired degree of polymerization and curing of the polymerizable compound(s) in the invention.

### —Recording Medium—

The recording medium used in the invention can be one which ink can or cannot penetrate.

Examples of the recording medium which ink can penetrate include plain paper, paper exclusively for ink-jet recording, coated paper, paper for both ink-jet recording and electrophotography, fabric, non-woven fabric, porous film, and polymeric absorbent. These recording media are described as “recording materials” in, for example, JP-A No. 2001-1891549.

The recording medium used in the invention is preferably one which ink cannot penetrate (non-absorptive) to effectively show the effect of the invention. Even when the ink is ejected on the recording medium which ink cannot penetrate, such as film, metal, or glass, the ink itself is cured in the exposure conducted after recording, which results in formation of an image having good adhesiveness with respect to the recording medium and high quality.

Examples of such a recording medium include art paper, a synthetic resin sheet, a rubber sheet, paper coated with a resin, glass, metal, ceramics, and wood. Alternatively, the recording medium may be a composite material made of at least two of these materials to obtain combined functions.

The synthetic resin may be any synthetic resin, and examples thereof include polyester resins such as polyethylene terephthalate and polybutadiene terephthalate; polyolefin resins such as polyethylene, and polypropylene; and polyvinyl chloride, polystyrene, polyurethane, acrylic resins, polycarbonate, acrylonitrile-butadiene-styrene terpolymer, diacetates, triacetates, polyimide, cellophane, and celluloid.

The shape and the thickness of the recording medium made of the synthetic resin are not particularly limited. The recording medium may be in the form of a film, a card, or a block, and the shape thereof is selected properly according to the intended usage of the ink composition. In addition, the synthetic resin may be transparent or opaque.

The shape of the recording medium made of the synthetic resin is preferably a film or sheet for so-called soft packaging, and various non-absorptive plastics and the films thereof may be used as the recording media. Examples of the plastic films include a PET film, an OPS film, an OPP film, an ONy film, a PVC film, a PE film, and a TAC film.

The paper coated with a resin may be a paper support having at least one surface covered with a polyolefin resin. For example, the paper support may have at least one surface on which the polyolefin is laminated. In the invention, the paper support preferably has surfaces on each of which a polyolefin resin is laminated.

As described above, image recording (image-forming method of the invention) using the ink composition of the invention can provide a rigid image having high quality and high strength. A recorded medium obtained, or a recorded medium of the invention has an image having good rigidity, good light resistance and good ozone resistance.

### EXAMPLES

Hereinafter, the invention will be described more specifically while referring the following Examples, but it should be understood that the invention is not restricted by these Examples. The “part” and “%” are “part by mass” and “% by mass”, unless specified otherwise.

### —Preparation of Recording Medium—

A polyethylene terephthalate sheet (PET sheet) having a thickness of 50 μm and a hard glass plate having a thickness of 2.5 mm were prepared as recording media for image recording.

### Example 1

The following components were mixed and stirred to prepare a magenta ink (1) of the invention.

| | |
|---|---|
| Metal-containing polymerizable compound (1) shown below | 2.0 g |
| (SAN ESTER SK-30 manufactured by Sanshin Chemical | |
| Industry Co., Ltd.) | |
| ACMO | 18 g |
| (polymerizable compound manufactured by Kohjin Co., Ltd.) | |
| IRGACURE 1870 | 0.6 g |
| (polymerization initiator manufactured by Ciba Specialty | |
| Chemicals) | |
| Magenta dye M-1 (oil-soluble dye) shown below | 0.2 g |

### Metal-Containing Polymerizable Compound (1)

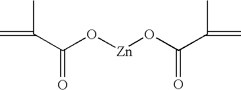

Magenta Dye M-1

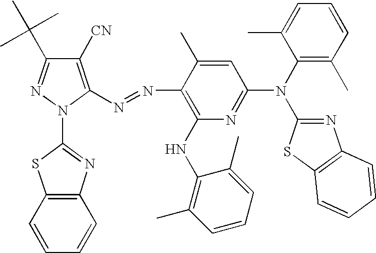

### Example 2

A magenta ink (2) of the invention was prepared in the same manner as in Example 1, except that the amounts of the metal-containing polymerizable compound (1) and ACMO (polymerizable compound) were changed to 1.0 g and 19.0 g, respectively.

### Example 3

A magenta ink (3) of the invention was prepared in the same manner as in Example 1, except that the amounts of the metal-containing polymerizable compound (1) and ACMO (polymerizable compound) were changed to 0.4 g and 19.6 g, respectively.

### Example 4

A magenta ink (4) of the invention was prepared in the same manner as in Example 1, except that 2.0 g of the metal-containing polymerizable compound (1) was replaced with 1.0 g of the following metal-containing polymerizable compound (2) (zinc monomethacrylate manufactured by Asada Chemical Industry Co. Ltd.) and the amount of ACMO (polymerizable compound) was changed to 19.0 g.

Metal-Containing Polymerizable Compound (2)

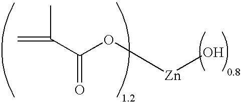

### Example 5

A magenta ink (5) of the invention was prepared in the same manner as in Example 1, except that 2.0 g of the metal-containing polymerizable compound (1) was replaced with 0.4 g of the metal-containing polymerizable compound (2) (zinc monomethacrylate manufactured by Asada Chemical Industry Co. Ltd.) and the amount of ACMO (polymerizable compound) was changed to 19.6.

### Comparative Example 1

A magenta ink (1′) for comparison was prepared in the same manner as in Example 1, except that metal-containing polymerizable compound was not contained and the amount of ACMO (polymerizable compound) was changed to 20 g.

### Image Recording and Evaluation

Each of the magenta inks of the invention and the magenta ink for comparison was ejected onto each of the hard glass and the PET sheet in an ink-jet printer having 64 nozzles at a printing density of 300 dpi at an ink-ejection frequency of 1 kHz. After the recording, the resultant image was irradiated with UV-A rays (having a wavelength of 320 to 390 nm) emitted by a UV lamp (manufactured by Fusion) at energy of 500 mJ/cm³. Thus, a color image sample was formed. The color image sample was evaluated as follows. Evaluation results are summarized in Table 1.

### 1. Printing Density

The printing density of the image was measured with a reflection densitometer (X-RITE938 manufactured by X-rite).

### 2. Adhesiveness

The color image, which was a cured film, was scratched vertically and horizontally with a cutter to form a checker pattern having five vertical lines and five lateral lines, and, in other words, 25 squares. An adhesive tape was bonded to the entire surface of the scratched color image, and then peeled off. The rate of the number of squares remaining on the hard glass plate or the PET sheet to the number (25) of the squares on the hard glass plate or the PET sheet before the bonding and peeling, (the number of residual squares/25)×100(%), was calculated.

TABLE 1

| | Metal- | | | | |
|---|---|---|---|---|---|
| | containing | | | | |
| | polymerizable | Composition | Printing | Adhesiveness | |
| | compound | ratio | density | Glass | PET |
| Example 1 | (1) | 10% | 1.96 | 100% | 100% |
| Example 2 | (1) | 5% | 1.52 | 100% | 100% |
| Example 3 | (1) | 2% | 1.40 | 100% | 100% |
| Example 4 | (2) | 5% | 1.49 | 100% | 100% |
| Example 5 | (2) | 2% | 1.35 | 100% | 40% |
| Comparative | None | 0% | 1.27 | 0% | 0% |
| Example 1 | | | | | |

Note)
In Table 1, the “Composition ratio” means the ratio of the amount of the metal-containing polymerizable compound to the total amount of the metal-containing polymerizable compound and the polymerizable compound.

As is apparent from Table 1, the magenta inks (1) to (5) of the invention including a combination of the metal-containing polymerizable compound and other polymerizable compound enables easy and stable formation of rigid color images which have highly adhesive and which do not easily peel off. The magenta inks (1) to (4) of the invention can show improved adhesiveness both to glass and PET and high printing density.

In contrast, the magenta ink (1′) for comparison containing no metal-containing polymerizable compound easily peeled off both from glass and PET and had inferior adhesiveness and inferior printing density.

1. An ink composition comprising a polymerizable compound and a metal-containing polymerizable compound.

2. The ink composition of claim 1, wherein the metal-containing polymerizable compound is a metal carboxylate compound.

3. The ink composition of claim 1, wherein the metal-containing polymerizable compound contains zinc.

4. The ink composition of claim 1, wherein the ratio of the mass of the metal-containing polymerizable compound (y) to the total mass of the polymerizable compound (x) and the metal-containing polymerizable compound (y), (y/(x+y)×100), is 0.2 to 12%.

5. The ink composition of claim 1, further comprising a polymerization initiator.

6. The ink composition of claim 1, further comprising a colorant.

7. The ink composition of claim 6, wherein the colorant is a pigment or dye.

8. The ink composition of claim 6, wherein the colorant is an oil-soluble dye.

9. The ink composition of claim 7, wherein the colorant is a dye having an oxidation potential of more than 1.0 V with respect to a saturated calomel electrode.

10. The ink composition of claim 1, wherein the ink composition is for use in ink-jet recording.

11. A method for forming an image, comprising: ejecting the ink composition of claim 1 by ink-jet recording to record an image on a recording medium.

12. A method for forming an image, comprising: recording an image on a recording medium with the ink composition of claim 1 and irradiating the image with active energy rays to cure the image.

13. The method for forming an image of claim 12, wherein the image is recorded by an ink-jet recording method of ejecting the ink composition.

14. A recorded medium having an image recorded by using the ink composition of claim 1.
